(19) United States
(12) Patent Application Publication
(10) Pub. No.: US 2024/0187282 A1
(43) Pub. Date: Jun. 6, 2024

(54) ELECTRONIC DEVICE FOR WIRELESS COMMUNICATION, WIRELESS COMMUNICATION METHOD, AND STORAGE MEDIUM

(71) Applicant: Sony Group Corporation, Tokyo (JP)

(72) Inventors: Mingtuo ZHOU, Shanghai (CN); Min LIU, Beijing (CN)

(73) Assignee: Sony Group Corporation, Tokyo (JP)

(21) Appl. No.: 18/284,554

(22) PCT Filed: Apr. 1, 2022
(86) PCT No.: PCT/CN2022/084770

§ 371 Date: Sep. 28, 2023

(30) Foreign Application Priority Data
Apr. 6, 2021 (CN) 202110367215.7

(51) Int. Cl. H04L 25/02; H04W 24/08

(52) U.S. Cl. CPC H04L 25/0224; H04W 24/08

(57) ABSTRACT

Provided are an electronic device for wireless communication, a wireless communication method, and a storage medium. The electronic device for wireless communication may comprise a processing circuit. The processing circuit may be configured to interact with a network side device to perform joint channel estimation or joint beam scanning executed in cooperation with other terminal devices in a terminal device group, wherein the terminal devices in the terminal device group have similar channel characteristics. According to at least one aspect of the embodiments of the present disclosure, by means of the similarity of the channel characteristics of the terminal devices in the terminal device group, these terminal devices execute joint channel estimation and/or beam scanning in cooperation with each other rather than perform channel estimation or beam scanning independently, thereby facilitating the reduction of signaling overhead, power consumption and/or time.

The present disclosure claims priority to Chinese Patent Application No. 202110367215.7, titled “ELECTRONIC DEVICE FOR WIRELESS COMMUNICATIONS, WIRELESS COMMUNICATION METHOD, AND STORAGE MEDIUM”, filed on Apr. 6, 2021 with the China National Intellectual Property Administration, which is incorporated herein by reference in its entirety.

### FIELD

The present disclosure relates to the technical field of wireless communications, and in particular to an electronic device for wireless communications, a wireless communication method, and a non-transitory computer readable storage medium which facilitate multiple terminal devices to cooperate with each other for a channel estimation and/or a beam scanning.

### BACKGROUND

The Internet of Things based on a non-terrestrial network (hereinafter also referred to as non-terrestrial Internet of Things) has attracted more attention because of its huge application prospect. Such an Internet of Things has a large number of terminal devices, which may be installed in very similar locations (for example, within 100 meters or even within 10 meters) and surrounding environments of which are also very similar. In contrast, a distance between a terminal device and a satellite is usually more than 300 kilometers, and may even reach nearly 10,000 kilometers. Therefore, compared with the distance from the terminal device to the satellite, a distance between adjacent terminal devices is basically negligible. From a satellite side (network side), adjacent terminal devices have no difference in location or environment, and may have very similar channel characteristics.

However, in the conventional art, the above characteristics of adjacent terminal devices in the non-terrestrial Internet of Things have not been noticed, let alone effectively utilized.

### SUMMARY

A brief summary of the present disclosure is provided below, in order to provide a basic understanding of certain aspects of the present disclosure. It should be understood, however, that this summary is not an exhaustive summary of the present disclosure. It is neither intended to determine key or important parts of the present disclosure, nor intended to limit a scope of the present disclosure. A purpose of the summary is only to provide some concepts in a simplified manner, serving as a preamble of a more detailed description described later.

In view of the above problems, according to the present disclosure, a concept of taking terminal devices with similar channel characteristics in, for example, but not limited to, non-terrestrial Internet of Things as a terminal device group is proposed. An object of at least one aspect of the present disclosure is to provide an electronic device for wireless communications, a wireless communication method, and a non-transitory computer readable storage medium, which utilize the similarity of channel characteristics of terminal devices in a terminal device group to enable these terminal devices to perform a joint channel estimation and/or beam scanning in a cooperative manner.

According to an aspect of the present disclosure, an electronic device for wireless communications is provided. The electronic device includes a processing circuit configured to interact with a network side device to perform a joint channel estimation or a joint beam scanning in cooperation with other terminal devices in a terminal device group, where all terminal devices in the terminal device group have similar channel characteristics.

According to another aspect of the present disclosure, an electronic device for wireless communications is further provided. The electronic device includes a processing circuit configured to interact with a terminal device in a terminal device group, where the terminal device performs a joint channel estimation or a joint beam scanning in cooperation with other terminal devices in the terminal device group, where all terminal devices in the terminal device group have similar channel characteristics.

According to another aspect of the present disclosure, a wireless communication method, for example, performed by a terminal device in a terminal device group is further provided. The method includes interacting with a network side device to perform a joint channel estimation or a joint beam scanning in cooperation with other terminal devices in a terminal device group, where all terminal devices in the terminal device group have similar channel characteristics.

According to another aspect of the present disclosure, a wireless communication method is further provided. The method includes interacting with a terminal device in a terminal device group, where the terminal device performs a joint channel estimation or a joint beam scanning in cooperation with other terminal devices in the terminal device group, where all terminal devices in the terminal device group have similar channel characteristics.

According to another aspect of the present disclosure, a non-transitory computer readable storage medium storing executable instructions is further provided. The executable instructions, when executed by a processor, cause the processor to perform the wireless communication method or various functions of the electronic device for wireless communications.

According to other aspects of the present disclosure, computer program code and a computer program product for implementing the method according to the present disclosure are further provided.

According to at least one aspect of an embodiment of the present disclosure, the similarity of channel characteristics of terminal devices in a terminal device group is utilized, so that these terminal devices do not perform a channel estimation or a beam scanning independently, but cooperate with each other (for example, interact with a network side device in a cooperative manner) to perform a joint channel estimation and/or beam scanning, which is beneficial to saving signaling overhead, power consumption and/or time, etc.

Other aspects of the embodiments of the present disclosure are set forth in the following description, in which preferred embodiments for fully disclosing the embodiments of the present disclosure are described in detail without being limited thereto.

### BRIEF DESCRIPTION OF THE DRAWINGS

The drawings described herein are for illustrating selected embodiments only rather than all possible implementations, and are not intended to limit the scope of the present disclosure. In the drawings:

FIG. 1 is a schematic diagram for explaining an example of dividing a frequency band of interest into multiple narrow frequency bands:

FIG. 2 is a schematic diagram for explaining an example flow of adding a terminal device to a terminal device group:

FIG. 3 is a schematic diagram showing an example of multiple terminal device groups:

FIG. 4 is a schematic diagram for explaining an example flow of updating a terminal device group:

FIG. 5 is a block diagram showing a configuration example of an electronic device on a terminal device side according to an embodiment of the present disclosure:

FIG. 6 is an explanatory diagram for explaining an example in which terminal devices in a terminal device group transmit SRS signals in turn:

FIG. 7 is an explanatory diagram for explaining an example in which terminal devices in a terminal device group constitute virtual transmission groups to transmit SRS signals:

FIG. 8 is an explanatory diagram for explaining an example in which each of terminal devices in a terminal device group transmits an SRS signal based on a battery energy level;

FIG. 9 is an explanatory diagram for explaining an example in which each of terminal devices in a terminal device group transmits an SRS signal in a different narrow frequency band:

FIG. 10 is an explanatory diagram for explaining an example in which each of terminal devices in a terminal device group transmits an SRS signal with a different phase:

FIG. 11 is an explanatory diagram for explaining an example in which terminal devices in a terminal device group perform a joint beam scanning on reception beams:

FIG. 12 is an explanatory diagram for explaining an example in which beam directions of adjacent terminal devices in a terminal device group are not completely aligned:

FIG. 13 is a block diagram showing a configuration example of an electronic device on a network side according to an embodiment of the present disclosure:

FIG. 14 is a flowchart for explaining an example of an information interaction process of a joint beam scanning that can be implemented according to a preferred embodiment of the present disclosure:

FIG. 15 is a flowchart for explaining an example of an information interaction process of a joint beam scanning that can be implemented according to another preferred embodiment of the present disclosure:

FIG. 16 is a flowchart for explaining an example of an information interaction process of beam alignment processing that can be implemented according to a preferred embodiment of the present disclosure:

FIG. 17 is a flowchart showing a process example of a wireless communication method on a terminal device side according to an embodiment of the present disclosure:

FIG. 18 is a flowchart showing a process example of a wireless communication method on a network side according to an embodiment of the present disclosure:

FIG. 19 is a block diagram showing a first example of a schematic configuration of an eNB to which the technology of the present disclosure may be applied:

FIG. 20 is a block diagram showing a second example of a schematic configuration of an eNB to which the technology of the present disclosure may be applied:

FIG. 21 is a block diagram showing an example of a schematic configuration of a smartphone to which the technology of the present disclosure may be applied: and

FIG. 22 is a block diagram showing an example of a schematic configuration of a car navigation device to which the technology of the present disclosure may be applied.

Although various modifications and alternations are easily made to the present disclosure, specific embodiments of the present disclosure are shown in the drawings by examples, and are described in detail herein. It should be understood that description for the specific embodiments herein is not intended to limit the present disclosure to the specific form as disclosed. Instead, the present disclosure aims to cover all modifications, equivalents and alternations within the spirit and scope of the present disclosure. It is noted that throughout the drawings, corresponding reference numerals indicate corresponding parts.

### DETAILED DESCRIPTION OF THE EMBODIMENTS

Examples of the present disclosure are fully disclosed with reference to the drawings. The following description is merely illustrative and is not intended to limit the present disclosure and applications or usage thereof.

Exemplary embodiments are provided, so that the present disclosure becomes thorough and the scope thereof is fully conveyed to those skilled in the art. Numerous specific details such as examples of specific components, devices and methods are set forth to provide a thorough understanding of embodiments of the present disclosure. It is apparent for those skilled in the art that, exemplary embodiments may be implemented in various ways without these specific details, which should not be constructed as limiting the scope of the present disclosure. In some exemplary embodiments, well-known processes, structures and technologies are not described in detail.

Description is made in the following order:
1. Overview of a terminal device group
2. Configuration example of an electronic device on a terminal device side
   2.1 Example processing related to a joint channel estimation
   2.2 Example processing related to a joint beam scanning
3. Configuration example of an electronic device on a network side
   3.1 Example processing related to a joint channel estimation
   3.2 Example processing related to a joint beam scanning
   3.3 Example signaling interaction related to a joint beam scanning
4. Method embodiments
5. Application example

### 1. Overview of a Terminal Device Group

As mentioned above, in the non-terrestrial Internet of Things, from a satellite side (network side), adjacent terminal devices have no difference in location or environment, and may have very similar channel characteristics. However, in the conventional art, this has not been found, let alone utilized. In processing such as a channel estimation and a beam scanning, multiple terminal devices independently transmit or receive reference signals for the channel estimation or beam management, resulting in signaling waste, power consumption waste and/or time waste.

In view of the above problems, the inventor puts forward a concept of terminal device group, in which multiple terminal devices with similar channel characteristics are taken as a terminal device group, so that in processing such as a channel estimation and a beam scanning, the similarity of channel characteristics of terminal devices in the group may be utilized (in other words, the channel characteristics of terminal devices in the group are equivalent to or substituted for each other to some extent), and joint processing may be achieved by these terminal devices cooperating with each other in a way that, for example, appears to work as one terminal device as a whole.

First, by taking a terminal device group with similar uplink channel characteristics (hereinafter sometimes referred to as “terminal device group with similar uplink channels” for simplicity) as an example, an example of similar uplink channel characteristics, an example flow of adding a terminal device to a terminal device group, and an example flow of updating a terminal device group are described.

In an example in which all terminal devices in a terminal device group have similar uplink channel characteristics, there is at least one type of quasi-co-location (QCL) relationship between Sounding Reference Signal (SRS) antenna ports of all terminal devices, that is, there is at least one type of QCL relationship in the following types A to D.

In type A, exhibitions of all terminal devices are similar in terms of Doppler Shift, Doppler Spread, Average Delay and Delay Spread.

In type B, exhibitions of all terminal devices are similar in terms of Doppler Shift and Doppler Spread.

In type C, exhibitions of all terminal devices are similar in terms of Average Delay and Delay Spread.

In type D, exhibitions of all terminal devices are similar in terms of spatial reception parameters (such as arrival angle or departure angle).

In a case that one or more terminal device groups with similar uplink channels (for example, in which there is one or more types of QCL relationships in the types A to D between SRS antenna ports of all terminal devices) already exist, if a terminal device accesses a non-terrestrial Internet of Things base station or handovers to a new non-terrestrial Internet of Things base station, the terminal device may at least report its geographical location to the base station, and may also further report a battery energy level, a data arrival mode, the number and characteristics of antennas, a power transmission range and the like. The information may be transmitted through an uplink data channel (including Medium Access Control Control Element (MAC CE)) or an uplink control channel.

The serving base station may assign the terminal device accessing or handovering to the base station to an existing terminal device group with similar uplink channels in a very close location based on relevant information at least including the geographical location reported by the terminal device, and schedule the terminal device to transmit multiple reference signals, such as SRS signals, for a channel estimation together with other terminal devices in the group.

As an example, all terminal devices may transmit SRS signals on one or more narrow frequency bands. FIG. 1 is a schematic diagram for explaining an example of dividing a frequency band of interest into multiple narrow frequency bands. In the application of non-terrestrial Internet of Things, as shown in FIG. 1, the frequency band of interest may be divided into multiple narrow frequency bands f1, f2, f3, . . . and fn, so that a width of each of narrow frequency bands is suitable for a non-terrestrial Internet of Things terminal to transmit an SRS signal for an uplink channel estimation and beam management. By transmitting the SRS signal in such a narrow frequency band, the SRS signal may have a higher energy spectral density, which is beneficial for the channel estimation and beam management.

The serving base station may evaluate or estimate an uplink channel characteristic of a current terminal device based on the received SRS signal transmitted by the terminal device, and compare the uplink channel characteristic with uplink channel characteristics of other members in the existing “terminal group with similar uplink channels” which are evaluated based on SRS signals transmitted by these members, to determine whether to add the terminal device to the “terminal device group with similar uplink channels”. For example, in a case that the current terminal device and other members in the “terminal device group with similar uplink channels” have similar uplink channel characteristics, it is determined that the current terminal device may be added to the terminal device group.

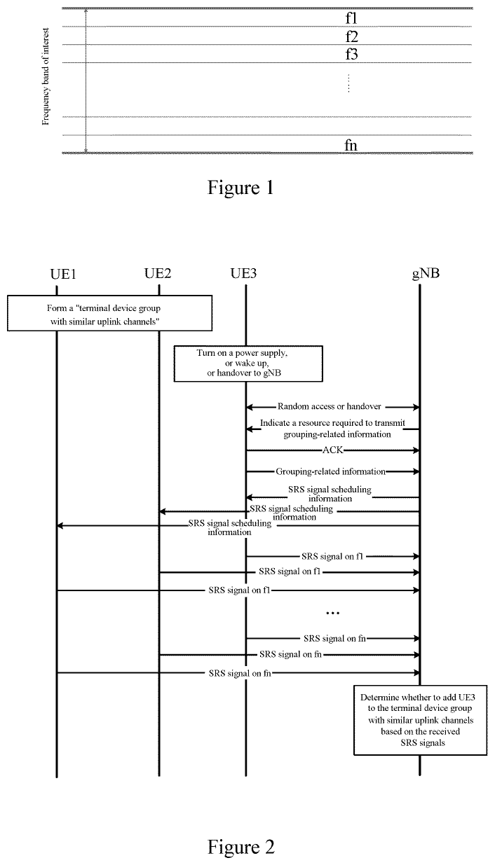

FIG. 2 is a schematic diagram for explaining an example flow of adding a terminal device to a terminal device group. In an example of FIG. 2, two terminal devices UE1 and UE2 that are adjacent to each other and have similar uplink channel characteristics have formed a “terminal device group with similar uplink channels”, and UE3 is a terminal device that has just turned on a power supply, woken up, or handed over to a current serving base station gNB. After UE3 accesses or hands over to the serving base station gNB, the serving base station gNB allocates a resource to UE3 for the terminal 3 to transmit grouping-related information including at least a geographical location, an optional battery energy level, a data arrival mode, the number and characteristics of antennas, a transmission power range and the like. After receiving the message, UE3 transmits an acknowledgement message ACK to illustrate the reception of the message. Then, UE3 reports the grouping-related information to the serving base station gNB. The serving base station gNB reschedules a resource, and arranges UE1, UE2 and UE3 to transmit SRS signals, for example, on a same frequency resource by transmitting scheduling information to these terminals. For example, UE1, UE2 and UE3 may transmit SRS signals on multiple narrow frequency bands f1 . . . fn as shown in FIG. 1, respectively. After receiving these SRS signals, the serving base station gNB evaluates uplink channel characteristics of the terminal devices UE1 to UE3 based on these SRS signals, and compares the uplink channel characteristic of UE3 with those of UE1 and UE2. In a case that these channel characteristics are similar, the serving base station gNB determines to add UE3 to the “terminal device group with similar uplink channels” composed of UE1 and UE2. On the contrary, the serving base station gNB determines that UE3 should not be added to the terminal device group.

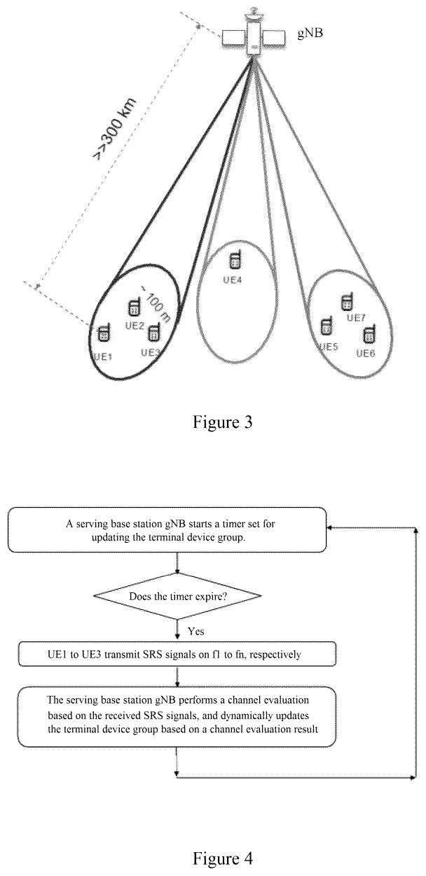

As an example, assuming that the serving base station gNB determines that UE3 is added to the “terminal device group with similar uplink channels” composed of UE1 and UE2, an example of the terminal group and other existing “terminal device groups with similar uplink channels” may be shown in FIG. 3. FIG. 3 is a schematic diagram showing an example of multiple terminal device groups, more specifically multiple “terminal device groups with similar uplink channels”, in which UE1 to UE3 constitute a first terminal device group, UE4 alone constitutes a second terminal device group, and UE5 to UE7 constitute a third terminal device group. A distance between these terminal devices and the serving base station gNB, which is a satellite, for example, is much greater than 300 KM, and the terminal devices in each of the terminal device groups are, for example, distributed within a range of about 100 meters in diameter.

Here, a flow of constructing a new terminal device group may be similar to the example flow of adding the terminal device to the terminal device group described above with reference to FIG. 2, for example. For example, in a case that the current terminal device fails to be added to any existing terminal device group (or there is no terminal device group yet), the terminal device itself may be regarded as a terminal device group with only one member. For example, the second terminal device group of UE4 shown in FIG. 3 is such a case.

Moreover, for the terminal device groups as shown in FIGS. 2 and 3, they may be updated due to the movement of the serving base station or terminal device in addition to the addition of the terminal device that has just turned on the power supply, woken up, or handed over to the current serving base station.

More specifically, if a satellite as the serving base station is a non-geostationary satellite, it always moves relative to a ground, and terminal devices in the non-terrestrial Internet of Things may also move, leading to dynamic update of a terminal device group. In an updating process of “terminal device group with similar uplink channels”, for example, the serving base station schedules the transmission of SRS signals for all terminal devices in the terminal device group, estimates uplink channel characteristics of the terminal devices based on the received SRS signals, and dynamically adjusts group members based on an estimation result. The test and evaluation for channel similarity may be carried out at a fixed time interval to dynamically adjust the members in the “terminal device group with similar uplink channels”.

FIG. 4 is a schematic diagram for explaining an example flow of updating a terminal device group. An example flow of updating the first terminal device group composed of UE1 to UE3 in FIG. 3 is shown. As shown in FIG. 4, the serving base station gNB regularly schedules the terminal devices UE1, UE2 and UE3 in the group to transmit SRS signals on the narrow frequency bands f1, f2, . . . and fn by setting a timer, performs a channel evaluation based on the received SRS signals, and dynamically updates the terminal device group based on a channel evaluation result. For example, a terminal device whose uplink channel characteristic is no longer similar to those of other members may be moved out of the terminal device group.

The example of the similar uplink channel characteristics, the example flow of adding the terminal device to the terminal device group, and the example flow of updating the terminal device group are described above by taking the terminal device group with similar uplink channels as the example. These examples are similarly applicable to a downlink scenario.

For example, in an example in which all terminal devices in a terminal device group have similar downlink channel characteristics, there is at least one type of QCL relationship between Channel State Information-Reference Signal (CSI-RS) antenna ports of all terminal devices, such as at least one type of QCL relationship in the aforementioned types A to D.

In a case that one or more terminal device groups with similar downlink channels (for example, in which there is one or more types of QCL relationships in the types A to D between CSI-RS antenna ports of all terminal devices) already exist, if a terminal device accesses a non-terrestrial Internet of Things base station or handovers to a new non-terrestrial Internet of Things base station, the terminal device may at least report its geographical location to the base station, and may also further report a battery energy level, a data arrival mode, the number and characteristics of antennas, a power transmission range and the like.

The serving base station may assign the terminal device accessing or handovering to the base station to an existing terminal device group with similar downlink channels in a very close location based on relevant information at least including the geographical location reported by the terminal device, and transmit multiple reference signals, such as CSI-RS signals, for a channel estimation to the terminal device and other terminal devices in the group. As an example, the base station may transmit CSI-RS signals to all terminal devices on one or more narrow frequency bands. All terminal devices receive the CSI-RS signals and evaluate downlink channel characteristics to report their respective downlink channel characteristics to the base station. The base station determines whether a current terminal device may be added to the group by comparing evaluation results of downlink channel characteristics between the current terminal device and other terminal devices in the group.

Alternatively, the base station may directly transmit CSI-RS signals to multiple geographically close terminal devices, and determine whether some or all of the terminal devices may form a terminal device group with similar downlink channels based on downlink channel characteristics reported by these terminal devices based on an evaluation of CSI-RS signals.

Moreover, in an updating process of “terminal device group with similar downlink channels”, for example, the base station transmits CSI-RS signals to all terminal devices in the terminal device group, all terminal devices estimate downlink channel characteristics based on the received CSI-RS signals and report to the base station, and the base station dynamically adjusts group members based on an estimation result. The test and evaluation for channel characteristic similarity may be carried out at a fixed time interval to dynamically adjust the members in the “terminal device group with similar downlink channels”.

Related examples of “terminal device group with similar uplink channels” and “terminal device group with similar downlink channels” have been described above, and these examples may be appropriately combined with each other. In other words, a terminal device group with similar uplink channel characteristics and similar downlink channel characteristics may be constructed/updated, the details of which are not repeated.

### 2. Configuration Example of an Electronic Device on a Terminal Device Side

Based on the terminal device group as described above, in processing such as a channel estimation and a beam scanning, the similarity of channel characteristics of terminal devices in the group may be utilized (in other words, the channel characteristics of terminal devices in the group are equivalent to or substituted for each other to some extent), and joint processing may be achieved by these terminal devices cooperating with each other in such a way that, for example, all terminal devices in the group appear to work as one terminal device as a whole.

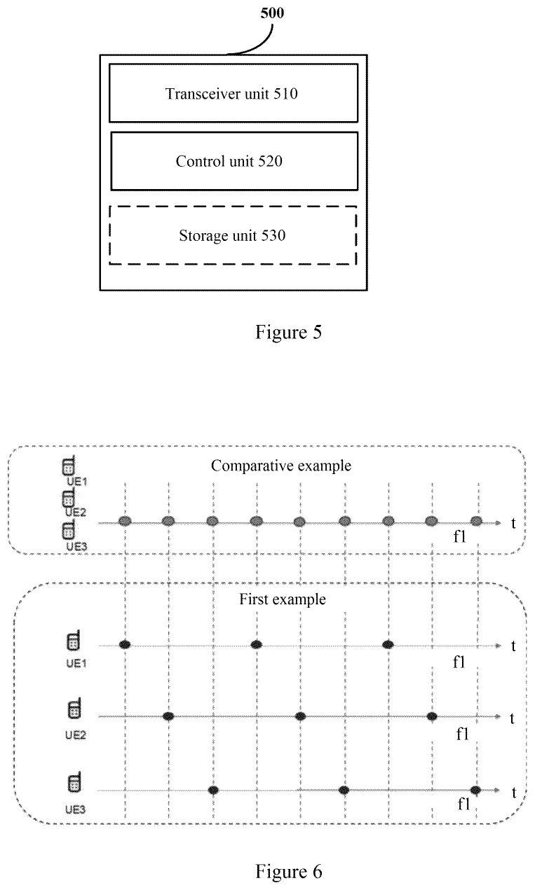

FIG. 5 is a block diagram showing a configuration example of an electronic device on a terminal device side according to an embodiment of the present disclosure.

As shown in FIG. 5, an electronic device 500 may include a transceiver unit 510, a control unit 520 and an optional storage unit 530.

Here, each unit of the electronic device 500 may be included in a processing circuit. It should be noted that the electronic device 500 may include one processing circuit or multiple processing circuits. Further, the processing circuit may include various discrete functional units to perform different functions and/or operations. It should be noted that these functional units may be physical entities or logical entities, and units with different names may be implemented by a same physical entity.

The electronic device 500 may be, for example, a terminal device itself in the non-terrestrial Internet of Things, or an electronic device attached to the terminal device. Hereinafter, for convenience of description, the electronic device 500 will be described as an example of the terminal device itself in the non-terrestrial Internet of Things, but those skilled in the art may understand that the embodiments of the present disclosure are not limited thereto.

According to an embodiment of the present disclosure, for example, the transceiver unit 510 of the electronic device 500 as the terminal device itself may interact with a network side device under the control of the control unit 520 to perform a joint channel estimation or a joint beam scanning in cooperation with other terminal devices in a terminal device group, where all terminal devices including the electronic device 500 in the terminal device group have similar channel characteristics.

As an example, the electronic device 500 may interact with the network side device to, for example, cooperate with other terminal devices in the terminal device group to transmit or receive reference signals for a channel estimation or a beam scanning which use at least partially different (e.g., “complementary” to some extent) time resources, frequency resources and/or spatial resources (e.g., beam resources), so that, for example, a joint channel estimation and/or beam scanning are achieved in such a way that all terminal devices in the group appear to work as one terminal device as a whole. Further, the electronic device 500 may share a result of the joint channel estimation and/or beam scanning with other terminal devices in the terminal device group, for example.

According to the present embodiment, the similarity of channel characteristics of terminal devices in a terminal device group is utilized, so that the terminal devices such as an electronic device 500 do not perform a channel estimation or a beam scanning independently, but cooperate with the terminal devices in the terminal device group to perform a joint channel estimation and/or beam scanning, thereby contributing to saving signaling overhead, power consumption and/or time, etc.

Examples related to a joint channel estimation and a joint beam scanning that may be performed by the electronic device 500 are further described below:

### 2.1 Example Processing Related to a Joint Channel Estimation

For a joint channel estimation, an electronic device according to the present embodiment, such as the electronic device 500, may interact with a network side device to, for example, transmit or receive reference signals for a channel estimation with other terminal devices in a terminal device group in a mutually cooperative manner. Such cooperation may include, for example, that the electronic device and other terminal devices in the terminal device group transmit or receive reference signals for the channel estimation that use at least partially different (e.g., “complementary” to some extent) time resources and/or frequency resources (in other words, the electronic device transmits or receives the reference signal that uses time-frequency resources in cooperation with other terminal devices in the terminal device group), or transmit or receive reference signals for the channel estimation with different phases, so that, for example, it seems as if one terminal device transmits or receives all these reference signals as a whole to achieve the joint channel estimation.

Hereinafter, a specific example related to a joint channel estimation that may be performed by the electronic device according to the present embodiment is described in combination with an example of a terminal device group with similar uplink channels as appropriate.

As an example in which the electronic device 500 transmits or receives the reference signal that uses time-frequency resources in cooperation with other terminal devices in the terminal device group, the control unit 520 of the electronic device 500 may control the transceiver unit 510 to transmit or receive a reference signal (such as an SRS signal or a CSI-RS signal) for a channel estimation based on a time resource and/or a frequency resource, such as received via the transceiver unit 510 (and optionally stored in the storage unit 530), indicated by the network side device to perform the joint channel estimation, where the time resource and/or the frequency resource are different from a resource of the reference signal transmitted or received by at least another terminal device in the terminal device group.

In this way, for example, a set of time resources and/or frequency resources of reference signals transmitted or received by all terminal devices in the terminal device group may preferably be equivalent to time resources and/or frequency resources of reference signals that one terminal device is required to transmit or receive to independently achieve its channel estimation. Thus, the joint channel estimation is performed in a cooperative manner of all terminal devices (equivalent to one terminal device).

In an example of an uplink scenario, the reference signal for the channel estimation may, for example, be a periodic, semi-static or aperiodic SRS, and the network side device indicating the time resource and/or frequency resource for transmitting the SRS signal may be implemented via configuration information of the SRS signal, activation information of the semi-static SRS signal, a scheduling command of the aperiodic SRS signal or the like. For the sake of conciseness, these may be collectively referred to as scheduling information of the reference signal such as the SRS signal hereinafter. A time resource and/or a frequency resource indicated by scheduling information of the SRS signal obtained by the electronic device 500 from the network side device are different from a time resource and/or a frequency resource indicated by scheduling information of the SRS signal of at least another terminal device in the terminal device group. First to fourth examples in which an electronic device transmits or receives a reference signal using time-frequency resources in cooperation with other terminal devices in a terminal device group are described below:

In the first example, a time resource for transmitting or receiving the reference signal for the channel estimation indicated by the network side device acquired by the electronic device 500 is different from a time resource of the reference signal transmitted or received by other terminal devices in the terminal device group.

Description is made by taking the uplink scenario as an example. For example, transmission time of a periodic SRS signal indicated in configuration information of the SRS signal acquired by the electronic device 500 is different from transmission time of SRS signals of other terminal devices in the terminal device group. That is, all terminal devices in the terminal device group transmit SRS signals sequentially or in turn.

FIG. 6 is an explanatory diagram for explaining an example in which terminal devices in a terminal device group transmit SRS signals in turn. An example time sequence in which terminal devices transmit SRS on a narrow frequency band f1 with time t according to a comparative example and a first example is shown. It is noted that although not shown in FIG. 6, the terminal devices according to the comparative example and the first example may all transmit SRS signals in a similar manner on more narrow frequency bands (for example, narrow frequency bands f2 . . . and fn shown in FIG. 1). More specifically, according to the comparative example (i.e., an example in which there is no terminal device group or no cooperation in the group), three terminal devices UE1 to UE3 may transmit SRS signals for an uplink channel estimation independently of each other in a conventional art manner. An upper side of FIG. 6 schematically shows a time sequence in which UE2 in the comparative example transmits SRS signals, and although it is not shown in FIG. 6 for simplicity, UE1 and UE3 transmit SRS signals in the same way as UE2. According to the first example, a lower side of FIG. 6 shows a schematic diagram in which three terminal devices UE1, UE2 and UE3 constituting the first terminal device group as shown in FIG. 3 transmit SRS signals in turn on a narrow frequency band f1 by using different time resources, where the terminal devices may all have the function of the electronic device 500, for example. Obviously, with processing of the first example as shown in FIG. 6, according to the embodiment of the present disclosure, signaling overhead is saved and power consumption of the terminal devices is reduced. Here, although not shown in FIG. 6, the terminal devices according to the comparative example and the first example may all transmit SRS signals in a similar manner on more narrow frequency bands (for example, narrow frequency bands f2, . . . and fn shown in FIG. 3).

In the second example, a time resource for transmitting or receiving the reference signal for the channel estimation indicated by the network side device acquired by the electronic device 500 is the same as a time resource of the reference signal transmitted or received by a first terminal device in the terminal device group, and different from a time resource of the reference signal transmitted or received by a second terminal device in the terminal device group.

Description is made by taking the uplink scenario as an example. For example, transmission time of a periodic SRS signal indicated in configuration information of the SRS signal acquired by the electronic device 500 is the same as transmission time of the SRS signal of the first terminal device in the terminal device group, but different from transmission time of the SRS signal of the second terminal device in the terminal device group. In this way, the electronic device 500 and the first terminal device form a first virtual transmission group, and the second terminal device (and optionally, another terminal device in the terminal device group, etc.) forms a second virtual transmission group (and optionally, more virtual transmission groups), which may transmit SRS signals at different time (sequentially). The number of virtual transmission groups in the terminal device group and the number of terminal devices in each virtual transmission group that simultaneously transmit SRS signals may be appropriately set, for example, based on capabilities of the terminal devices, which is not limited here.

As an example only, in a case that the number of terminal devices is the same in all virtual transmission groups, configurations of the virtual transmission groups of terminal devices may be represented by mTnR SRS transmission groups, where m and n are each natural numbers greater than 1, m represents the number of terminal devices that simultaneously transmit SRS signals in each virtual transmission group (i.e., the number of terminal devices that transmit SRS signals each time), and n represents the total number of terminal devices that participate in transmitting SRS in turn (for example, which may be the total number of terminals in the terminal device group).

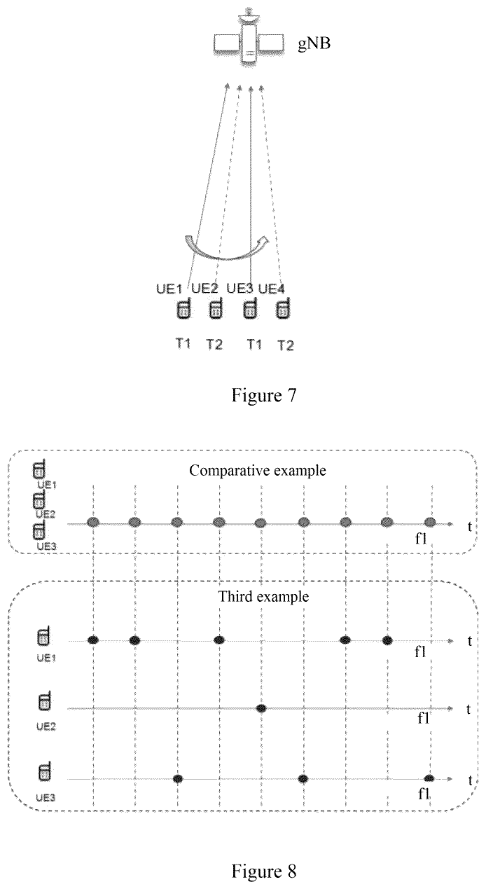

FIG. 7 is an explanatory diagram for explaining an example in which terminal devices in a terminal device group constitute virtual transmission groups to transmit SRS signals. In the example of FIG. 7, multiple terminal devices UE1 to UE4 constitute a terminal device group (where each terminal device may include or be implemented by the function of the electronic device 500 according to the present embodiment, for example), and a 2T4R SRS transmission group is adopted. That is, a total of four terminal devices are divided into virtual transmission groups of two terminal devices in each group, where UE1 and UE3 constitute a first virtual transmission group, and UE2 and UE4 constitute a second virtual transmission group. At first time T1, UE1 and UE3 of the first virtual transmission group simultaneously transmit SRS signals, and at second time T2 later, UE2 and UE4 of the second virtual transmission group simultaneously transmit SRS signals. Moreover, such an alternating transmission may be repeated.

The configuration in which terminal devices form virtual transmission groups to transmit SRS as shown in FIG. 7 is particularly beneficial for the non-terrestrial Internet of Things application. In order to save the cost, terminal devices in the non-terrestrial Internet of Things may only have one antenna. Thus, it is impossible to transmit SRS signals on different antennas to improve the quality of channel evaluation. However, because multiple non-terrestrial Internet of Things terminal devices with similar uplink channel characteristics constitute a terminal device group and further constitute virtual transmission groups, these terminal devices as a whole may transmit SRS signals as if they are transmitting SRS signals on different antennas, which is beneficial to improving the quality of channel evaluation.

In the third example, the control unit 520 of the electronic device 500 may further be configured to report a battery energy level of the electronic device 500 to the network side device, for example, via the transceiver unit 510. Accordingly, time indicated by the time resource for transmitting or receiving the reference signal for the channel estimation indicated or allocated by the network side device for the electronic device 500 corresponds to the number of times that the electronic device 500 transmits or receives the reference signal, which is determined based on the battery energy level of the electronic device 500 and battery energy levels of other terminal devices in the terminal device group.

Description is made by taking the uplink scenario as an example. For example, the number of transmission of an aperiodic SRS signal indicated in scheduling information of the SRS signal acquired by the electronic device 500 is determined by the network side device based on a battery energy level of the electronic device 500 and battery energy levels of other terminal devices in the terminal device group. This manner may be called an energy-fair SRS transmission scheme. For example, a terminal device with a higher battery energy level may undertake more SRS signal transmission, while a terminal device with a lower battery energy level may undertake less transmission or even no SRS signal transmission. In this way, it is especially beneficial to reducing power consumption of a terminal device with a lower battery energy level.

FIG. 8 is an explanatory diagram for explaining an example in which each of terminal devices in a terminal device group transmits an SRS signal based on a battery energy level. An example time sequence in which terminal devices transmit SRS on a narrow frequency band f1 with time t according to a comparative example and a third example is shown (although not shown in FIG. 8, the terminal devices according to the comparative example and the third example may all transmit SRS signals in a similar manner on more narrow frequency bands). Similar to FIG. 6, according to the comparative example (i.e., an example in which there is no terminal device group or no cooperation in the group), an upper side of FIG. 8 shows a time sequence in which a terminal device UE2 independently transmits SRS signals, and UE1 and UE3 independently transmit SRS signals (not shown in FIG. 8) in the same way as UE2. According to the third example, a lower side of FIG. 8 shows a schematic diagram in which terminal devices UE1, UE2 and UE3 constituting the first terminal device group as shown in FIG. 3 transmit SRS signals using different time resources based on the number of transmission determined by the network side based on battery energy levels, where the terminal devices may all have the function of the electronic device 500, for example. In the example of FIG. 8, UE1 has a highest battery energy level to transmit SRS the most times, while UE3 and UE2 have successively lower battery energy levels to transmit SRS in the middle and the least times, respectively. In this way, it is especially beneficial to reducing power consumption of terminal devices UE3 and UE2 with lower battery energy levels.

In the fourth example, a frequency resource for transmitting or receiving the reference signal for the channel estimation indicated by the network side device acquired by the electronic device 500 is in a different narrow frequency band from a frequency resource of the reference signal transmitted or received by at least another terminal device in the terminal device group.

As described above with reference to FIG. 1, in the non-terrestrial Internet of Things application, the frequency band of interest may be divided into multiple narrow frequency bands, and the terminal devices may transmit SRS signals on one or more narrow frequency bands (for example, narrow frequency bands f1, f2 . . . and fn in FIG. 1) to perform the channel estimation. In this example, frequency resources of reference signals of all terminal devices in the terminal device group may be in different narrow frequency bands within the frequency band of interest, for example, so as to be beneficial to evaluating channel characteristics in the frequency band of interest formed by these narrow frequency bands.

Description is made by taking the uplink scenario as an example. For example, a frequency resource of a periodic SRS signal indicated in configuration information of the SRS signal acquired by the electronic device 500 is in a different narrow frequency band from a frequency resource of the SRS signal of at least another terminal device in the terminal device group. Preferably, frequency resources of SRS signals of all terminal devices in the terminal device group are in different narrow frequency bands, and a set of these narrow frequency bands constitutes the whole frequency band of interest.

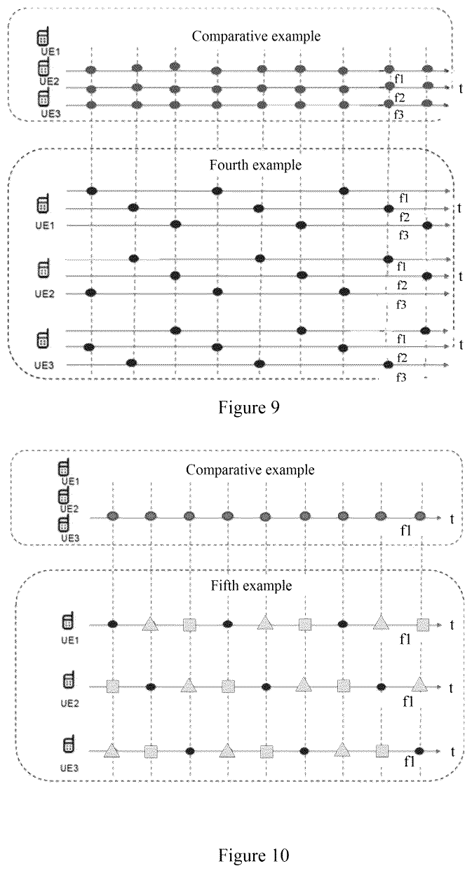

FIG. 9 is an explanatory diagram for explaining an example in which each of terminal devices in a terminal device group transmits an SRS signal in a different narrow frequency band. An example time sequence in which terminal devices transmit SRS on narrow frequency bands f1, f2 and f3 with time t according to a comparative example and a fourth example is shown. According to the comparative example (i.e., an example in which there is no terminal device group or no cooperation in the group), an upper side of FIG. 9 schematically shows a time sequence in which terminal devices UE1, UE2 and UE3 transmit SRS for an uplink channel estimation, where each of terminal devices should transmit SRS on multiple narrow frequency bands, such as f1, f2 and f3, respectively. In a time sequence of a current time period shown in FIG. 9, a case in which UE1, UE2 and UE3 respectively transmit SRS signals in narrow frequency bands f1, f2 and f3 is shown. Here, although not shown, in a subsequent period, UE1 is required to transmit SRS signals on narrow frequency bands f2 and f3, UE2 is required to transmit SRS signals on narrow frequency bands f1 and f3, and UE3 is required to transmit SRS signals on narrow frequency bands f1 and f2. In other words, the upper side of FIG. 9 only shows one third of a whole process of transmitting SRS signals by each of terminal devices in the conventional art.

According to the fourth example, a lower side of FIG. 9) shows a schematic diagram in which terminal devices UE1, UE2 and UE3 constituting the first terminal device group as shown in FIG. 3 simultaneously transmits SRS on different narrow frequency bands f1, f2 and f3 based on frequency resources indicated by the network side device, where the terminal devices may all have the function of the electronic device 500, for example. As shown in FIG. 9, in an example time sequence of the fourth example shown in FIG. 9, the whole terminal device group has already transmitted SRS signals on the narrow frequency bands f1, f2 and f3 in one third of the whole process of transmitting SRS signals in the comparative example, and these SRS signals may be used by the network side to evaluate uplink channel characteristics of the whole terminal device group (in other words, the network side regards the whole terminal device group as one terminal device). Therefore, according to this example, it is not only beneficial to saving signaling overhead and reducing power consumption of devices, but also particularly beneficial to reducing time spent on channel estimation.

On the other hand, an example in which an electronic device according to the present embodiment, such as the electronic device 500, and other terminal devices in the terminal device group transmit or receive reference signals for a channel estimation in a mutually cooperative manner may further include transmitting or receiving reference signals for the channel estimation with different phases, thereby achieving a joint channel estimation. A fifth example of a reference signal with a different phase is described below:

In the fifth example, the control unit 520 of the electronic device 500 may, for example, control the transceiver unit 510 to transmit or receive a precoded reference signal for a channel estimation based on precoding information indicated by the network side device to perform the joint channel estimation. A phase of the reference signal is different from a phase of the reference signal for the channel estimation transmitted or received by at least another terminal device in the terminal device group. Preferably, phases of reference signals of all terminal devices in the terminal device group may be different from each other. In this way, reference signals with different phases transmitted or received by all terminal devices in the terminal device group are beneficial to a multi-dimensional evaluation of channel characteristics.

Description is made by taking the uplink scenario as an example. The control unit 520 of the electronic device 500 may, for example, control the transceiver unit 510 to transmit a precoded SRS signal based on precoding information indicated by the network side device (and optionally stored in the storage unit 530), a phase of which is different from a phase of the SRS signal transmitted by at least another terminal device in the terminal device group. The SRS signal may be precoded, for example, based on the precoding information indicated by the network side device through an antenna component in the transceiver unit 510, to have a specified phase.

FIG. 10 is an explanatory diagram for explaining an example in which each of terminal devices in a terminal device group transmits an SRS signal with a different phase. An example time sequence in which terminal devices transmit SRS on a narrow frequency band f1 with time t according to a comparative example and a fifth example is shown (although not shown in FIG. 10, the terminal devices according to the comparative example and the fifth example may all transmit SRS signals in a similar manner on more narrow frequency bands). Similar to FIG. 6, according to the comparative example (i.e., an example in which there is no terminal device group or no cooperation in the group), an upper side of FIG. 10 shows a time sequence in which a terminal device UE2 independently transmits SRS signals, and UE1 and UE3 independently transmit SRS signals (not shown in FIG. 10) in the same way, where all terminal devices do not pay special attention to phases of SRS signals (for example, SRS signals of all terminal devices may have a same phase). According to the fifth example, a lower side of FIG. 10 shows a schematic diagram in which terminal devices UE1, UE2 and UE3 constituting the first terminal device group as shown in FIG. 3 simultaneously transmit precoded SRS signals with different phases based on precoding information indicated by the network side device, where the terminal devices may all have the function of the electronic device 500, for example, and the different phases are schematically shown in FIG. 10 as circles, triangles and squares.

The first to fifth examples of the joint channel estimation according to the present embodiment have been described above with reference to FIGS. 6 to 10. On the basis of the above description, those skilled in the art may understand that these examples may be combined with each other under appropriate circumstances. That is, examples in which an electronic device cooperates with other terminal devices in a terminal device group to transmit/receive reference signals that use at least partially different (e.g., “complementary” to some extent) time resources and/or frequency resources and transmit/receive reference signals with different phases may be combined with each other, which is not repeated here.

In addition, specific examples of the joint channel estimation according to the present embodiment are described above by mainly taking the uplink scenario as the example. However, on the basis of the above description, those skilled in the art may understand that these examples may be appropriately applied to a downlink scenario, such as a scenario of receiving periodic, semi-static or aperiodic CSI-RS signals for a joint channel estimation. For example, the electronic device 500 may know a time-frequency resource allocated for a CSI-RS signal via configuration information and the like of the signal, and optionally know phase information of the signal via precoding information and the like. Accordingly, the electronic device 500 may, from the network side device, receive CSI-RS signals using at least partially different time resources and/or frequency resources, or receive CSI-RS signals with different phases in a manner similar to that in the uplink scenario, for example, in a cooperative manner with other terminal devices in its terminal device group, so that, for example, it seems as if one terminal device transmits or receives all these CSI-RS signals as a whole to achieve the joint channel estimation.

For example, the electronic device 500 and other terminal devices in its terminal device group may receive periodic CSI-RS signals from the network side device at different time, for example, sequentially or in turn. Alternatively, similar to the configuration of the virtual transmission group, the electronic device 500 may also form a virtual reception group with terminal devices in its terminal device group. For example, the electronic device 500 may form a first virtual reception group with a first terminal device in the terminal device group, and a second terminal device (and optionally, another terminal device in the terminal device group, etc.) may form a second virtual reception group (and optionally, more virtual transmission groups), which may receive, for example, periodic CSI-RS signals at different time (sequentially or in turn). Moreover, the electronic device 500 and other terminal devices in its terminal device group may adopt an energy-fair CSI-RS reception scheme determined by the network side device, and undertake more or less CSI-RS reception based on battery energy levels. In addition, a frequency resource of a CSI-RS signal received by the electronic device 500 may be in a different narrow frequency band from a frequency resource of the CSI-RS signal received by at least another terminal device in its terminal device group. Preferably, frequency resources of CSI-RS signals received by all terminal devices in the terminal device group may be in different narrow frequency bands, and a set of these narrow frequency bands constitutes the whole frequency band of interest. In addition, a phase of a CSI-RS signal received by the electronic device 500 may be different from a phase of the CSI-RS signal received by at least another terminal device in its terminal device group.

Actually, a difference between the downlink scenario and the uplink scenario is mainly that the terminal device side may estimate channel characteristics of downlink channels based on received downlink reference signals. That is, in the downlink scenario, the electronic device 500 may not only receive downlink reference signals with at least partially different time resources, frequency resources and/or phases from the network side device with other terminal devices in its terminal device group, but also estimate the channel characteristics of the downlink channels based on the received downlink reference signals.

In other words, in a preferred embodiment, the electronic device 500 and other terminal devices in the terminal device group may have similar downlink channel characteristics (for example, but not limited to, there is at least one type of QCL relationship in the aforementioned types A to D between CSI-RS antenna ports of these terminal devices), and their cooperative joint channel estimation may include a downlink channel estimation. In this case, the electronic device 500 may measure a reference signal such as a CSI-RS signal received via the transceiver unit 510, for example, through the control unit 520. Moreover, for each of other terminal devices in the terminal device group, the electronic device 500 may obtain, from other terminal devices in the terminal device group, a measurement result by the terminal device for the received reference signal such as CSI-RS signal through the transceiver unit 510, and perform the downlink channel estimation through the control unit based on a result of measuring the reference signal performed by itself and the measurement result obtained from other terminal devices, that is, estimate the channel characteristics of the downlink channels based on all CSI-RS measurement results.

In this way, the electronic device 500 regards CSI-RS measurement results of other terminal devices in the terminal device group as its own CSI-RS measurement results, and estimates the channel characteristics of the downlink channels based on all CSI-RS measurement results. Alternatively, the electronic device 500 may provide a result of the downlink channel estimation performed by itself to the network side device, and then the network side device provides the result to other terminal devices in the terminal device group. Alternatively, in a case that direct Device to Device (D2D) communication may be conducted between the electronic device 500 and other terminal devices in the terminal device group, for example, via sidelink, the result of the downlink channel estimation performed by the electronic device 500 may be directly provided to other terminal devices in the terminal device group.

The example related to the joint channel estimation that may be performed by the electronic device 500 according to the embodiment of the present disclosure has been described above. As mentioned above, with processing of the electronic device according to the embodiment of the present disclosure, the similarity of channel characteristics of terminal devices in a terminal device group where the electronic device is located may be utilized (in other words, the channel characteristics of terminal devices in the group are equivalent to or substituted for each other to some extent), and the electronic device cooperates with other terminal devices to transmit or receive reference signals for the channel estimation using at least partially different time resources and/or frequency resources, or transmit or receive reference signals for the channel estimation with different phases, so that, for example, it seems as if one terminal device transmits or receives all these reference signals as a whole to achieve the joint channel estimation, thereby being beneficial to saving signaling overhead, power consumption and/or time, etc.

### 2.2 Example Processing Related to a Joint Beam Scanning

For a joint beam scanning, an electronic device according to the present embodiment, such as the electronic device 500, may interact with a network side device to, for example, use transmission beams or reception beams to transmit or receive reference signals for beam management with other terminal devices in a terminal device group in a mutually cooperative manner. Such cooperation may include, for example, that the electronic device and other terminal devices in the terminal device group use at least partially different (e.g., with different beam directions) transmission beams or reception beams to transmit or receive reference signals for beam management, so that, for example, it seems as if one terminal device uses all these transmission beams or reception beams to transmit or receive reference signals as a whole to achieve the joint beam scanning.

Before describing an example of a joint beam scanning that may be performed by the electronic device 500, a background of beam management involved is briefly introduced first. Because of the consistency between an uplink beam and a downlink beam, that is, an optimal beam pair for downlink transmission is also an optimal beam pair for uplink transmission, the downlink transmission is described here as an example. For example, beam management for the downlink transmission may include the following three stages or states P1 to P3.

In P1, an initial beam is established. The initial beam is established, for example, at a stage of random access/connection establishment of a terminal device. For example, in a process of cell search, the terminal device acquires multiple Synchronization Signal Block (SSB) signals transmitted by a network side device such as a base station with different transmission beams (downlink beams), and it may detect a best downlink beam by measuring these SSB signals (for example, measuring their Reference Signal Receiving Power (RSRP)), and map it to a Random Access Channel (RACH) resource, so that the network side may know the downlink beam selected by the terminal device through the random access of the terminal device, thus establishing an initial beam pair (i.e., the selected downlink beam and a transmission beam of the terminal corresponding thereto).

In P2, a transmission beam (downlink beam) on the network side is adjusted, which occurs in a case that the beam is required to be adjusted after the initial beam is established. One of the reasons for beam adjustment may be the movement and rotation of the terminal device and the movement of objects in surrounding environments, resulting in the initial beam pair being no longer suitable. Other reasons may also include optimizing a beam shape, such as choosing a narrower beam than a wide beam in the initial beam. In a downlink beam adjustment stage, the network side transmits reference signals for beam management such as CSI-RS using different transmission beams, so that the terminal device may measure CSI-RS signals (transmission beam scanning) received by using, for example, a reception beam in the initial beam pair or a previously determined optimal reception beam and transmitted with different transmission beams, and determine a direction of a transmission beam corresponding to an optimal measurement result (for example, a highest RSRP) as an optimal transmission beam (downlink beam).

In P3, a reception beam of the terminal device is adjusted, which also occurs in a case that the beam is required to be adjusted after the initial beam is established. At this stage, the network side transmits reference signals for beam management such as CSI-RS using, for example, the transmission beam in the initial beam pair or a previously determined optimal transmission beam, and the terminal device measures CSI-RS signals (reception beam scanning) received by using different reception beams and transmitted with a given transmission beam, and determines a direction of a reception beam corresponding to an optimal measurement result (for example, a highest RSRP) as an optimal reception beam.

In a case that the terminal device is in an RRC connection state, the network side device such as a base station or TRP and the terminal device will handover between three stages or states P1, P2 and P3. In a process of beam selection in each state, the network side device (base station or TRP) or terminal device is required to perform a beam scanning to determine a direction corresponding to an optimal measurement result as an optimal beam direction.

In a preferred embodiment, the electronic device 500 according to the embodiment of the present disclosure may belong to a terminal device group with similar uplink channel characteristics, that is, an uplink similar terminal device group. In a preferred embodiment, the electronic device 500 may, for example, perform a joint beam scanning on the reception beams in cooperation with other terminal devices for a given transmission beam of the network side device in the above P3 stage, to directly determine, for example, a unified optimal reception beam of all terminal devices in the terminal device group. In addition, in an alternative preferred embodiment, due to beam consistency, for a given transmission beam of the network side device, the electronic device 500 may also perform a joint beam scanning on the transmission beams in cooperation with other terminal devices for the reception beam of the network side device corresponding to the transmission beam, to determine, for example, a unified optimal transmission beam of all terminal devices in the terminal device group, and correspondingly determine an optimal reception beam of the terminal device.

Here, the given transmission beam of the network side device may be determined for one terminal device in the terminal device group, for example, the transmission beam in the initial beam pair determined in the P1 stage or the optimal transmission beam determined in the previous P2 stage. Because the beam scanning is carried out separately for terminal devices in P1 stage and P2 stage, theoretically, the network side device may determine different optimal transmission beams for the terminal devices in the terminal device group. However, in view of the channel similarity of terminal devices in the terminal device group, the optimal transmission beams determined for the terminal devices are likely to be the same as each other. Even if the optimal transmission beams are different from each other, one of them may be regarded as the optimal transmission beam for the whole terminal device group, and the joint beam scanning according to the preferred embodiment may be performed on this basis. Hereinafter, a transmission beam of the network side device determined in any of the above ways is collectively referred to as a transmission beam used by the network side device (for the terminal device group/for terminal devices in the terminal device group).

According to a preferred embodiment, the transceiver unit 510 of the electronic device 500 may receive, using one or more reception beams, a downlink reference signal (for example, a downlink reference signal for beam management such as a CSI-RS signal) transmitted by the network side device using a transmission beam under the control of the control unit 520 to perform a joint beam scanning on the reception beams of the downlink reference signal. Here, the one or more reception beams used by the electronic device 500 are different from a reception beam used by at least another terminal device in the terminal device group to which the electronic device 500 belongs to receive the downlink reference signal. Preferably, the difference of the reception beams includes the difference of beam directions.

In this way, for example, a set of reception beams used by all terminal devices in the terminal device group may preferably be equivalent to reception beams used by one terminal device to independently achieve the reception beam scanning. Thus, the joint beam scanning is performed in a cooperative manner of all terminal devices (equivalent to one terminal device as a whole). For example, a set of beam directions of reception beams used by all terminal devices in the terminal device group may cover all or the whole directions of reception beams used by one terminal device to independently achieve the reception beam scanning. Accordingly, it is beneficial to saving signaling overhead, power consumption and/or time, etc. during beam scanning.

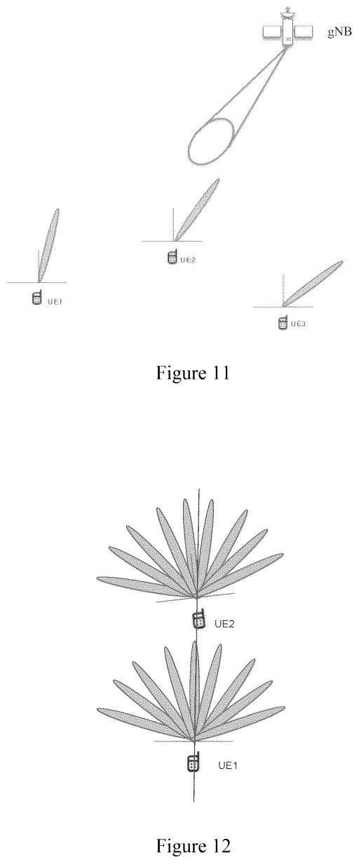

FIG. 11 is an explanatory diagram for explaining an example in which terminal devices in a terminal device group perform a joint beam scanning on reception beams. FIG. 11 shows a schematic diagram in which three terminal devices UE1, UE2 and UE3 constituting the first terminal device group as shown in FIG. 3 receive CSI-RS signals transmitted by a network side device gNB using a given transmission beam by using reception beams with different beam directions, where the terminal devices may all have the function of the electronic device 500, for example. For simplicity, FIG. 11 only shows a case in which each of terminal devices uses one reception beam for beam scanning, but in fact, it may use more reception beams.

In an example of a joint beam scanning as shown in FIG. 11, reception beams used by the electronic device 500 may be indicated or determined by scanning beam information. Scanning beam information of all terminal devices in the terminal device group may be provided by a maker of a joint beam scanning strategy, and the information indicates one or more reception beams used by the terminal device. Preferably, a set of beam directions of reception beams indicated by scanning beam information of all terminal devices in the terminal device group may cover all or the whole directions of reception beams used by one terminal device to independently achieve the reception beam scanning.

In an embodiment, the electronic device 500 itself is not the maker of the joint beam scanning strategy. At this time, the electronic device 500 may, for example, obtain scanning beam information indicating the one or more reception beams from the network side device or a first terminal device in the terminal device group as the maker of the joint beam scanning strategy via the transceiver unit 510, and report a measurement result (e.g., RSRP) of a downlink reference signal such as a CSI-RS signal received using the one or more reception beams to the network side device or the first terminal device. Accordingly, the electronic device 500 may further, for example, obtain optimal beam information, which indicates an optimal reception beam determined based on a measurement result by each of the terminal devices in the terminal device group, from the network side device or a first terminal device as the maker of the joint beam scanning strategy via the transceiver unit 510. For example, the optimal reception beam may be a reception beam corresponding to a best measurement result (e.g., a highest RSRP).

More specifically, in a first example, the network side device is the maker of the joint beam scanning strategy, and the network side device determines and provides scanning beam information to all terminal devices in the terminal device group. At this time, the electronic device 500 may receive the scanning beam information provided by the network side device. Alternatively, after receiving the scanning beam information, the electronic device 500 may transmit an acknowledgement message to the network side device, or one terminal device in the terminal device group may transmit an acknowledgement message to the network side device on behalf of the group. Thereafter, the electronic device 500 may measure the downlink reference signal such as the CSI-RS signal received by using the reception beams based on an indication of the scanning beam information, report a measurement result (such as RSRP) to the network side device, and obtain optimal beam information from the network side device.

Alternatively, in a second example, in a case that there is direct communication, such as sidelink, between the terminal devices in the terminal device group where the electronic device 500 is located, the terminal devices in the group may negotiate through the direct communication. Moreover, for example, the first terminal device therein is the maker of the joint beam scanning strategy, and it determines and provides scanning beam information to other terminal devices. At this time, the electronic device 500 may acquire the scanning beam information from the first terminal device. Thereafter, the electronic device 500 may measure based on an indication of the scanning beam information, report its own measurement result (such as RSRP) to the first terminal device, and obtain optimal beam information from the first terminal device.

In another embodiment, the electronic device 500 itself may be the maker of the joint beam scanning strategy. At this time, there is direct communication, such as sidelink, between the terminal devices in the terminal device group where the electronic device 500 is located. The terminal devices in the group may negotiate through the direct communication. The electronic device 500, as the maker of the joint beam scanning strategy, determines and provides scanning beam information to other terminal devices. In other words, at this time, the electronic device 500 may implement the function of the first terminal device in the second example described above. The electronic device 500 may be configured to: for each of other terminal devices in the terminal device group, provide scanning beam information to the terminal device, where the scanning beam information indicates one or more reception beams used by the terminal device to receive the downlink reference signal: obtain a measurement result of a downlink reference signal such as a CSI-RS signal received using the indicated one or more reception beams from the terminal device: and determine an optimal reception beam based on a measurement result by each of the terminal devices in the terminal device group. Alternatively, the electronic device 500 may further transmit optimal beam information indicating the determined optimal reception beam to each of the terminal devices.

In addition, according to an alternative preferred embodiment, due to beam consistency, the electronic device 500 may also cooperate with other terminal devices to perform a joint beam scanning of transmission beams to determine an optimal transmission beam of the terminal device, so as to determine the optimal transmission beam of the terminal device accordingly.

According to the alternative embodiment, the transceiver unit 510 of the electronic device 500 may transmit an uplink reference signal such as an SRS signal to the network side device using one or more transmission beams under the control of the control unit 520 to perform a joint beam scanning on the transmission beams of the uplink reference signal. Here, the one or more transmission beams used by the electronic device 500 are different from a transmission beam used by at least another terminal device in the terminal device group to transmit the uplink reference signal. Preferably, the difference of the transmission beams includes the difference of beam directions.

In this way, a set of transmission beams used by all terminal devices in the terminal device group may be, for example, preferably equivalent to transmission beams used by one terminal device to independently achieve the transmission beam scanning. Thus, the joint beam scanning is performed in a cooperative manner of all terminal devices (equivalent to one terminal device as a whole). For example, a set of beam directions of transmission beams used by all terminal devices in the terminal device group may cover all or the whole directions of transmission beams used by one terminal device to independently achieve the transmission beam scanning. Accordingly, it is beneficial to saving signaling overhead, power consumption and/or time, etc. during beam scanning.

Similar to the preferred embodiment previously described with reference to FIG. 11, in the present alternative embodiment, transmission beams used by the electronic device 500 may be indicated or determined by scanning beam information. Scanning beam information of all terminal devices in the terminal device group may be provided by a maker of a joint beam scanning strategy, and the information indicates one or more reception beams used by the terminal device. For example, the electronic device 500 may, for example, obtain scanning beam information indicating the one or more transmission beams from the network side device or other terminal devices in the terminal device group as the maker of the joint beam scanning strategy via the transceiver unit 510. In the former case, the network side device determines and provides scanning beam information to all terminal devices in the terminal device group. In the latter case, in a case that there is direct communication, such as sidelink, between the terminal devices in the terminal device group where the electronic device 500 is located, the terminal devices in the group may negotiate through the direct communication, and for example, one of the terminal devices is the maker of the joint beam scanning strategy, and determines and provides scanning beam information to other terminal devices.

Optionally, the electronic device 500 may further, for example, receive optimal beam information, which indicates an optimal transmission beam determined by the network side device based on an uplink reference signal such as an SRS signal received from each of terminal devices in the terminal device group and transmitted using the transmission beams, from the network side device via the transceiver unit 510. Here, the network side device may receive SRS signals transmitted by all terminal devices using their respective transmission beams by using the reception beam in the initial beam pair or a reception beam determined after the previous beam is adjusted (for example, a reception beam corresponding to the initial transmission beam or the previously determined optimal transmission beam in the downlink transmission scene), and measure these SRS signals to determine an optimal transmission beam based on obtained measurement results (for example, RSRP). For example, a transmission beam corresponding to an optimal measurement result (e.g., a highest RSRP) may be determined as the optimal transmission beam.

As mentioned above, due to beam consistency; after the optimal transmission beam of all terminal devices in the terminal device group is determined in a manner according to the alternative embodiment, a reception beam corresponding thereto may be determined as an optimal reception beam of all terminal devices.

The preferred and alternative embodiments of the joint beam scanning that may be performed by the electronic device 500 according to the embodiment of the present disclosure have been described above. With the above embodiments, the electronic device and other terminal devices in the terminal device group may use at least partially different (e.g., with different beam directions) transmission beams or reception beams to transmit or receive reference signals for beam management, so that, for example, it seems as if one terminal device uses all these transmission beams or reception beams to transmit or receive reference signals as a whole to achieve the joint beam scanning, thereby saving signaling overhead, power consumption and/or time, etc. during beam scanning.

In the above embodiments, multiple reception beams or transmission beams used by all terminal devices in the terminal device group are regarded as being equivalent to multiple reception beams or transmission beams used by a single terminal device, to perform joint beam scanning processing. Considering the accuracy of joint beam scanning, it is expected that reception beams of all terminal devices in the terminal device group should be aligned with each other as much as possible, so as to be suitable for being equivalent to or substituted for each other.

However, in reality, even if beam patterns of two adjacent terminal devices in the terminal device group are exactly the same, beam directions of each other may not be completely aligned due to installation and other reasons. FIG. 12 is an explanatory diagram for explaining an example in which beam directions of adjacent terminal devices in a terminal device group are not completely aligned. FIG. 12 shows a case in which beam directions (for example, beam directions of reception beams) of two adjacent terminal devices UE1 and UE2 in the first terminal device group composed of UE1 to UE3 as shown in FIG. 3 are not completely aligned.

Therefore, according to a further preferred embodiment, beam alignment processing may be performed in advance before joint beam scanning processing, so that beam directions of the terminal devices may be aligned, thereby improving the accuracy of the joint beam scanning processing.

More specifically, according to a further preferred embodiment, before performing the joint beam scanning, the electronic device 500 may, for example, transmit an uplink reference signal such as an SRS signal in directions of the reception beams for the downlink reference signal transmitted by the network side device using the transmission beam via the transceiver unit 510. Due to beam consistency, in actual processing, the electronic device 500 may, for example, transmit the SRS signal using transmission beams corresponding to the reception beams via the transceiver unit 510. The electronic device 500 may, for example, further obtain beam adjustment information determined based on the received uplink reference signal from the network side device via the transceiver unit 510, and for example, adjust beam directions of the reception beams to be used by the transceiver unit 510 based on the beam adjustment information via the control of the control unit 520 for beam alignment. Scanning beam information used in subsequent joint beam scanning processing is preferably determined based on a result of the beam alignment of each of the terminal devices in the terminal device group.

Preferably, in order for each of the terminal devices in the terminal device group (which has the function of the electronic device 500, for example) to perform the above beam alignment processing, beam directions of reception beams of each of the terminal devices may be aligned based on requirements of the network side, so as to correct a deviation among the beam directions of the reception beams of different terminal devices. UE1 and UE2 shown in FIG. 12 are taken as an example. It is assumed that each of them has the function of the electronic device 500, and after the above beam alignment processing, beam directions of reception beams of UE1 may remain unchanged, while beam directions of reception beams of UE2 may be rotated to the right as a whole, so that the beam directions of both are consistent or aligned with each other. On the basis that the deviation among the beam directions of the reception beams of each of the terminal devices in the terminal device group is corrected, a set of the beam directions of the reception beams of the terminal devices indicated by the determined scanning beam information of the terminal devices may be exactly equivalent to a set of beam directions of reception beams of a single terminal device (for example, to cover a complete scanning range).

On the other hand, after each of the terminal devices in the terminal device group performs the above beam alignment processing, although the beam directions of the reception beams of each of the terminal devices may be aligned based on the requirements of the network side, there is still a certain deviation among the beam directions of the reception beams of different terminal devices (for example, the deviation may be determined at the same time when the network side device determines the beam adjustment information, or it may be determined later based on a report on beam directions from each of the terminal devices). At this time, a device as a maker of a joint beam scanning strategy of such as the network side device may correct (relatively calibrate) the beam directions of the reception beams of different terminal devices by itself on the basis of this deviation in a case of making the scanning strategy or determining the scanning beam information, so that a set of the beam directions of the reception beams of the terminal devices indicated by the finally determined scanning beam information of the terminal devices may be exactly equivalent to a set of beam directions of reception beams of a single terminal device (for example, to cover a complete scanning range).

As an example, optionally, the above beam alignment processing performed by the electronic device 500 may be started by, for example, first receiving a beam alignment indication message from the network side device via the transceiver unit 510. In the non-terrestrial Internet of Things application, the beam alignment indication message received by the electronic device 500 may be transmitted by the network side device to each of the terminal devices in the terminal device group to which the electronic device 500 belongs at the same time, which may include, for example, scheduled time for carrying out beam alignment, and may optionally further include a setting of a reception antenna, a frequency, a satellite ID, ephemeris or ephemeris information of a satellite (in a case that the terminal devices do not know the ephemeris or ephemeris information in advance) and the like. After receiving the message, the electronic device 500 and other terminal devices in the terminal device group may transmit an acknowledgement message to the network side as a reply.

Thereafter, at the scheduled time indicated by the beam alignment indication message, the network side device transmits a downlink reference signal such as a CSI-RS signal by using a transmission beam to a geographical position direction of the terminal device group. The electronic device 500 may, based on the beam alignment indication message, for example, according to the ephemeris (ephemeris information) of the satellite included in the beam alignment indication message, optionally enable the transceiver unit 510 to perform omni-directional beam scanning with a satellite direction as a center through the control of the control unit 520, and may transmit the SRS signal in beam directions of the reception beams (for example, the beam directions with certain angular intervals from each other). The network side device receives the SRS signal of the terminal devices in the terminal device group including the electronic device 500, evaluates uplink channels of the terminal devices based on the received SRS signal, for example, to generate adjustment parameters of beam alignment of the terminal devices based on a result of channel evaluation, and transmits beam adjustment information indicating the adjustment parameters to the terminal devices. For example, the network side device may generate the above adjustment parameters based on the result of channel evaluation by using the existing beamforming technology, which is not described here.

The electronic device 500 may, for example, receive the beam adjustment information from the network side device via the transceiver unit 510, and for example, adjust beam directions of the reception beams to be used by the transceiver unit 510 based on the beam adjustment information via the control of the control unit 520 for beam alignment. After completing the adjustment, the electronic device 500 may, for example, transmit a completion message to the network side device, which may, for example, include beam directions of the reception beams after the beam alignment processing.

The further preferred embodiments of processing related to the joint beam scanning that may be performed by the electronic device 500 have been described above. With the preferred embodiments, the beam alignment processing may be performed in advance before the joint beam scanning processing, so that the beam directions of the terminal devices may be aligned, thereby improving the accuracy of the joint beam scanning processing. However, those skilled in the art may understand that the beam alignment processing is not necessary. Due to the similarity of channel characteristics among terminal devices in the terminal device group, even if the joint beam scanning processing is directly performed without the beam alignment processing, generally an acceptable beam scanning result may be obtained.

### 3. Configuration Example of an Electronic Device on a Network Side

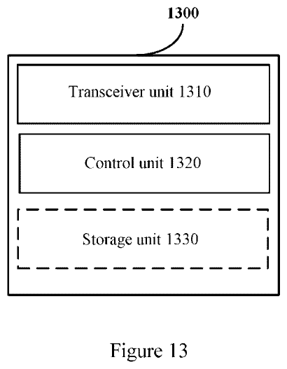

Corresponding to the configuration example of the electronic device on the terminal device side described above, a configuration example of an electronic device on a network side according to an embodiment of the present disclosure is described in detail below: FIG. 13 is a block diagram showing a configuration example of an electronic device on a network side according to an embodiment of the present disclosure.

As shown in FIG. 13, an electronic device 1300 may include a transceiver unit 1310, a control unit 1320 and an optional storage unit 1330.

Here, each unit of the electronic device 1300 may be included in a processing circuit. It should be noted that the electronic device 1300 may include one processing circuit or multiple processing circuits. Further, the processing circuit may include various discrete functional units to perform different functions and/or operations. It should be noted that these functional units may be physical entities or logical entities, and units with different names may be implemented by a same physical entity.

The electronic device 1300 may be, for example, a base station in the non-terrestrial Internet of Things or TRP itself, or an electronic device attached thereto. Hereinafter, for convenience of description, the electronic device 1300 will be described as an example of the base station itself in the non-terrestrial Internet of Things, but those skilled in the art may understand that the embodiments of the present disclosure are not limited thereto.

According to an embodiment of the present disclosure, for example, the transceiver unit 1310 of the electronic device 1300 as the base station itself may interact with a terminal device in a terminal device group under the control of the control unit 1320, so that the terminal device performs a joint channel estimation or a joint beam scanning in cooperation with other terminal devices in the terminal device group, where all terminal devices in the terminal device group have similar channel characteristics.

As an example, the electronic device 1300 may interact with the terminal device in the terminal device group, so that the terminal device, for example, cooperates with other terminal devices in the terminal device group to transmit or receive reference signals for a channel estimation or a beam scanning which use at least partially different (e.g., “complementary” to some extent) time resources, frequency resources and/or spatial resources (e.g., beam resources), so that, for example, a joint channel estimation and/or beam scanning are achieved in such a way that all terminal devices in the group appear to work as one terminal device as a whole. Further, the electronic device 1300 may enable all terminal devices in the terminal device group to share a result of the joint channel estimation and/or beam scanning, for example.

According to the present embodiment, the similarity of channel characteristics of terminal devices in the terminal device group is utilized, so that the terminal devices in the terminal device group do not perform a channel estimation or a beam scanning independently, but cooperate with each other to perform a joint channel estimation and/or beam scanning, thereby contributing to saving signaling overhead, terminal power consumption and/or time, etc.

Examples of processing of a joint channel estimation and a joint beam scanning that may be performed by the electronic device 1300 by interacting with a terminal device in a terminal device group are further described below.

### 3.1 Example Processing Related to a Joint Channel Estimation

In order to enable a terminal device in a terminal device group to perform a joint channel estimation, an electronic device according to the present embodiment, such as the electronic device 1300, may interact with the terminal device in the terminal device group, so that all terminal devices transmit or receive reference signals for a channel estimation, for example, in a mutually cooperative manner. Such cooperation may include, for example, that all terminal devices transmit or receive reference signals for the channel estimation that use at least partially different (e.g., “complementary” to some extent) time resources and/or frequency resources (in other words, all terminal devices transmit or receive reference signals that use time-frequency resources cooperatively), or transmit or receive reference signals for the channel estimation with different phases, so that, for example, it seems as if one terminal device transmits or receives all these reference signals as a whole to achieve the joint channel estimation.

Hereinafter, a specific example of processing related to a joint channel estimation performed by the electronic device 1300 according to the present embodiment is described in combination with an example of a terminal device group with similar uplink channels as appropriate.

As an example of enabling all terminal devices in the terminal device group to transmit or receive the reference signals that use time-frequency resources cooperatively, the control unit 1320 of the electronic device 1300 may control the transceiver unit 1310 to indicate a time resource and/or a frequency resource of a reference signal (such as an SRS signal or a CSI-RS signal) for a channel estimation to the terminal device in the terminal device group, so that the terminal device transmits or receives the reference signal based on the indicated time resource and/or frequency resource to perform the joint channel estimation, where the time resource and/or the frequency resource are different from a resource of the reference signal transmitted or received by at least another terminal device in the terminal device group.

In this way, for example, a set of time resources and/or frequency resources of reference signals transmitted or received by all terminal devices in the terminal device group may preferably be equivalent to time resources and/or frequency resources of reference signals that one terminal device is required to transmit or receive to independently achieve its channel estimation. Thus, the joint channel estimation is performed in a cooperative manner of all terminal devices (equivalent to one terminal device).

In an example of an uplink scenario, the reference signal for the channel estimation may, for example, be a periodic, semi-static or aperiodic SRS, and the electronic device 1300 as the network side device indicating the time resource and/or frequency resource for transmitting the SRS signal to the terminal device may be implemented by providing the terminal device with configuration information of the SRS signal, activation information of the semi-static SRS signal, a scheduling command of the aperiodic SRS signal or the like (For the sake of conciseness, the above information and command may be collectively referred to as scheduling information of the reference signal such as the SRS signal herein). A time resource and/or a frequency resource indicated by scheduling information of the SRS signal indicated by the electronic device 1300 to the current terminal device are different from a time resource and/or a frequency resource indicated by scheduling information of the SRS signal of at least another terminal device in the terminal device group. First to fourth examples in which the electronic device 1300 enables all terminal devices in a terminal device group to transmit or receive reference signals that use time-frequency resources cooperatively are described below.

In the first example, a time resource indicated by the electronic device 1300 to the current terminal device for transmitting or receiving the reference signal for the channel estimation is different from a time resource of the reference signal transmitted or received by other terminal devices in the terminal device group.

Description is made by taking the uplink scenario as an example. For example, transmission time of a periodic SRS signal indicated in configuration information of the SRS signal provided by the electronic device 1300 to the current terminal device is different from transmission time of SRS signals of other terminal devices in the terminal device group. That is, all terminal devices in the terminal device group transmit SRS sequentially or in turn. For a specific example of transmitting sequentially or in turn, reference may be, for example, made to the example described above with reference to FIG. 6, which is not repeated here.

According to the configuration of the first example, it is beneficial to saving signaling overhead and reducing power consumption of the terminal device. In the second example, a time resource indicated by the electronic device 1300 to the current terminal device for transmitting or receiving the reference signal for the channel estimation is the same as a time resource of the reference signal transmitted or received by a first terminal device in the terminal device group, and different from a time resource of the reference signal transmitted or received by a second terminal device in the terminal device group.

Description is made by taking the uplink scenario as an example. For example, transmission time of a periodic SRS signal indicated in configuration information of the SRS signal provided by the electronic device 1300 to the current terminal device is the same as transmission time of the SRS signal of the first terminal device in the terminal device group, but different from transmission time of the SRS signal of the second terminal device in the terminal device group. In this way, the current terminal device and the first terminal device may form a first virtual transmission group, and the second terminal device (and optionally, another terminal device in the terminal device group, etc.) forms a second virtual transmission group (and optionally, more virtual transmission groups), which may transmit SRS signals at different time (sequentially). The number of virtual transmission groups in the terminal device group and the number of terminal devices in each virtual transmission group that simultaneously transmit SRS signals may be appropriately set, for example, based on capabilities of the terminal devices, which is not limited here.

As an example only, in a case that the number of terminal devices is the same in all virtual transmission groups, configurations of the virtual transmission groups of terminal devices may be represented by mTnR SRS transmission groups, where m and n are each natural numbers greater than 1, m represents the number of terminal devices that simultaneously transmit SRS signals in each virtual transmission group (i.e., the number of terminal devices that transmit SRS signals each time), and n represents the total number of terminal devices that participate in transmitting SRS in turn (for example, which may be the total number of terminals in the terminal device group). For a specific example of the virtual transmission group, reference may be, for example, made to the example described above with reference to FIG. 7, which is not repeated here.

According to the second example, terminal devices of virtual transmission groups in the terminal device group as a whole may transmit SRS signals as if transmitting SRS signals on different antennas, thus contributing to improving the quality of channel evaluation. In the third example, the transceiver unit 1310 of the electronic device 1300 may further be configured to: for each of the terminal devices in the terminal device group, receive a battery energy level reported by the terminal device. Accordingly, the control unit 1320 of the electronic device 1300 may determine the number of times that the terminal device transmits or receives the reference signal based on the received battery energy level, and determine the time resource indicating time corresponding to the number of times.

Description is made by taking the uplink scenario as an example. For example, the number of transmission of an aperiodic SRS signal indicated in scheduling information of the SRS signal provided by the electronic device 1300 to the current terminal device is determined based on a battery energy level of each of the terminal devices in the terminal device group. This manner may be called an energy-fair SRS transmission scheme. For example, a terminal device with a higher battery energy level may undertake more SRS signal transmission, while a terminal device with a lower battery energy level may undertake less transmission or even no SRS signal transmission. For a specific example of the energy-fair SRS transmission scheme, reference may be, for example, made to the example described above with reference to FIG. 8, which is not repeated here. According to the third example, it is especially beneficial to reducing power consumption of a terminal device with a lower battery energy level.

In the fourth example, a frequency resource indicated by the electronic device 1300 to the current terminal device for transmitting or receiving the reference signal for the channel estimation is in a different narrow frequency band from a frequency resource of the reference signal transmitted or received by at least another terminal device in the terminal device group.

Description is made by taking the uplink scenario as an example. For example, a frequency resource of a periodic SRS indicated in configuration information of the SRS provided by the electronic device 1300 to the current terminal device is in a different narrow frequency band from a frequency resource of the SRS of at least another terminal device in the terminal device group. Preferably, frequency resources of SRS of all terminal devices in the terminal device group are in different narrow frequency bands, and a set of these narrow frequency bands constitutes the whole frequency band of interest. For a specific example of enabling all terminal devices to transmit SRS in different narrow frequency bands, reference may be, for example, made to the example described above with reference to FIG. 9, which is not repeated here. According to the fourth example, it is not only beneficial to saving signaling overhead and reducing power consumption of the terminal device, but also particularly beneficial to reducing time spent on channel estimation.

On the other hand, an example in which the electronic device 1300 according to the present embodiment enables terminal devices in a terminal device group to transmit or receive reference signals for a channel estimation in a mutually cooperative manner may further include enabling these terminal devices to transmit or receive reference signals for the channel estimation with different phases in a mutually cooperative manner, thereby achieving a joint channel estimation. A fifth example of a reference signal with a different phase is described below:

In the fifth example, the control unit 1320 of the electronic device 1300 may, for example, control the transceiver unit 1310 to indicate precoding information generated by the control unit 1320 to the current terminal device, so that the terminal device transmits or receives a precoded reference signal for a channel estimation based on the precoding information to perform the joint channel estimation, where a phase of the reference signal is different from a phase of the reference signal for the channel estimation transmitted or received by at least another terminal device in the terminal device group. Preferably, precoding information generated by the control unit 1320 for all terminal devices in the terminal device group may enable phases of precoded reference signals of all terminal devices in the terminal device group different from each other.

Description is made by taking the uplink scenario as an example. The current terminal device receiving the above precoding information may transmit a precoded SRS signal based on the precoding information, a phase of which is different from a phase of the SRS signal transmitted by at least another terminal device in the terminal device group. For a specific example of enabling all terminal devices to transmit SRS signals with different phases, reference may be, for example, made to the example described above with reference to FIG. 10, which is not repeated here. According to the fifth example, all terminal devices in the terminal device group may transmit or receive reference signals with different phases, thus facilitating a multi-dimensional evaluation of channel characteristics.

The first to fifth examples in which the electronic device 1300 according to the present embodiment may interact with a terminal device in a terminal device group to enable the terminal device to perform a joint channel estimation have been described above. On the basis of the above description, those skilled in the art may understand that these examples may be combined with each other under appropriate circumstances. That is, the electronic device 1300 may indicate time resources, frequency resources and/or precoding information, etc. to all terminal devices in the terminal device group, so that all terminal devices transmit/receive reference signals that use at least partially different (for example, “complementary” to some extent) time resources and/or frequency resources and/or have different phases, which is not repeated here.

In a preferred embodiment, the electronic device 1300 as the network side device interacts with a terminal device in a terminal device group with similar uplink channel characteristics to perform a joint channel estimation as an uplink channel estimation. For example, there may be at least one type of QCL relationship in the aforementioned types A to D between SRS antenna ports of all terminal devices in the terminal device group. In this case, for each of the terminal devices in the terminal device group, the electronic device 1300 may, for example, measure the reference signal such as the SRS signal received from the terminal device via the transceiver unit 1310 through the control unit 1320. In addition, the electronic device 1300 may perform the uplink channel estimation based on measurement results through the control unit 1320, that is, estimate channel characteristics of uplink channels based on all SRS measurement results.

In this way, the electronic device 1300 regards SRS measurement results of all terminal devices in the terminal device group as SRS measurement results of a single terminal device, and estimates the channel characteristics of the uplink channels based on all SRS measurement results to regard them as the channel characteristics of the uplink channels of all terminal devices in the terminal device group. Alternatively, the electronic device 1300 may provide the results of the uplink channel estimation performed by the electronic device 1300 to all terminal devices in the terminal device group.

Specific examples in which the electronic device according to the present embodiment may enable all terminal devices in the terminal device group to perform the joint channel estimation are described above by mainly taking the uplink scenario as the example. However, on the basis of the above description, those skilled in the art may understand that these examples may be appropriately applied to a downlink scenario, such as a scenario in which all terminal devices in a terminal device group receive periodic, semi-static or aperiodic CSI-RS signals for a joint channel estimation. For example, the electronic device 1300 may indicate a time-frequency resource allocated for a CSI-RS signal to a terminal device via configuration information and the like of the signal, and optionally indicate phase information of the signal to the terminal device via precoding information and the like. Accordingly, the terminal device that obtains the above information from the electronic device 1300 may, from the electronic device 1300, receive CSI-RS signals using at least partially different time resources and/or frequency resources, or receive CSI-RS signals with different phases in a manner similar to that in the uplink scenario, for example, in a cooperative manner with other terminal devices in its terminal device group, so that, for example, it seems as if one terminal device receives all these CSI-RS signals as a whole to achieve the joint channel estimation.

For example, the electronic device 1300 may transmit periodic CSI-RS signals to all terminal devices in a terminal device group at different time, so that all terminal devices receive the CSI-RS signals sequentially or in turn. Alternatively, similar to the configuration of the virtual transmission group, the electronic device 1300 may also divide the terminal devices in the terminal device group into a virtual reception group. For example, a current terminal device in the terminal device group may form a first virtual reception group with a first terminal device, and a second terminal device (and optionally, another terminal device in the terminal device group, etc.) may form a second virtual reception group (and optionally, more virtual transmission groups). The electronic device 1300 may transmit periodic CSI-RS signals to terminal devices in these virtual reception groups at different time (sequentially or in turn), so that the terminal devices in the virtual reception groups receive the periodic CSI-RS signals at different times (sequentially or in turn). Moreover, the electronic device 1300 may determine an energy-fair CSI-RS reception scheme for all terminal devices in the terminal device group, that is, transmit more or fewer CSI-RS to each of the terminal devices based on battery energy levels, so that each of the terminal devices receives more or fewer CSI-RS signals based on the battery energy levels. In addition, a frequency resource of a CSI-RS signal transmitted by the electronic device 1300 to the current terminal device may be in a different narrow frequency band from a frequency resource of the CSI-RS signal transmitted to at least another terminal device in its terminal device group. Preferably, frequency resources of CSI-RS signals transmitted to all terminal devices in the terminal device group may be in different narrow frequency bands, so that frequency resources of the CSI-RS signals received by all terminal devices may be in different narrow frequency bands, and a set of these narrow frequency bands preferably constitutes the whole frequency band of interest. In addition, a phase of a CSI-RS signal transmitted by the electronic device 1300 to the current terminal device may be different from a phase of the CSI-RS signal transmitted to at least another terminal device in its terminal device group, so that preferably, phases of CSI-RS signals received by all terminal devices may be different from each other.

The example in which the electronic device 1300 according to the embodiment of the present disclosure may interact with a terminal device in a terminal device group to perform a joint channel estimation has been described above. As mentioned above, with processing of the electronic device according to the embodiment of the present disclosure, the similarity of channel characteristics of all terminal devices in the terminal device group may be utilized (in other words, the channel characteristics of the terminal devices in the group are equivalent to or substituted for each other to some extent), and these terminal devices cooperate with each other to transmit or receive reference signals for a channel estimation using at least partially different time resources and/or frequency resources, or transmit or receive reference signals for the channel estimation with different phases, so that, for example, it seems as if one terminal device transmits or receives all these reference signals as a whole to achieve the joint channel estimation, thereby being beneficial to saving signaling overhead, power consumption and/or time, etc. For various details not described here, reference may be made to the above-described examples of the configuration and processing of the electronic device on the user equipment side.

### 3.2 Example Processing Related to a Joint Beam Scanning

For a joint beam scanning, an electronic device according to the present embodiment, such as the electronic device 1300, may interact with a terminal device in a terminal device group, so that the terminal device (current terminal device) uses transmission beams or reception beams to transmit or receive reference signals for beam management, for example, with other terminal devices in the terminal device group in a mutually cooperative manner. Such cooperation may include, for example, that the current terminal device and other terminal devices in the terminal device group use at least partially different (e.g., with different beam directions) transmission beams or reception beams to transmit or receive reference signals for beam management, so that, for example, it seems as if one terminal device uses all these transmission beams or reception beams to transmit or receive reference signals as a whole to achieve the joint beam scanning.

In a preferred embodiment, the electronic device 1300 according to the embodiment of the present disclosure may interact with a terminal device in a terminal device group with similar uplink channel characteristics, that is, in an uplink similar terminal device group. In a preferred embodiment, the electronic device 1300 may, for example, use a given transmission beam to transmit reference signals to the terminal device group in the P3 stage (beam adjustment stage of the terminal device) described earlier, and enable a current terminal device in the terminal device group to perform a joint beam scanning on reception beams by cooperating with other terminal devices, to directly determine, for example, a unified optimal reception beam of all terminal devices in the terminal device group. In addition, in an alternative preferred embodiment, due to beam consistency, for reference signals transmitted by the electronic device 1300 to the terminal device group using a given transmission beam, all terminal devices in the terminal device group may also cooperate with each other to perform a joint beam scanning on transmission beams for the reception beam of the network side device corresponding to the transmission beam, to determine, for example, a unified optimal transmission beam of all terminal devices in the terminal device group, and correspondingly determine an optimal reception beam of the terminal device. The above joint beam scanning is performed, for example, in the P3 stage described earlier.

More specifically, according to a preferred embodiment, the transceiver unit 1310 of the electronic device 1300 may transmit a downlink reference signal (for example, a downlink reference signal for beam management such as a CSI-RS signal) to a terminal device in a terminal device group using a transmission beam under the control of the control unit 1320, so that the current terminal device receives the downlink reference signal using one or more reception beams to perform a joint beam scanning on the reception beams of the downlink reference signal. Here, the one or more reception beams used by the current terminal device are different from a reception beam used by at least another terminal device in the terminal device group to receive the downlink reference signal. Preferably, the difference of the reception beams includes the difference of beam directions.

In this way, for the downlink reference signal transmitted by the electronic device 1300 to the terminal device in the terminal device group by using the transmission beam, a set of reception beams used by all terminal devices in the terminal device group may preferably be equivalent to reception beams used by one terminal device to independently achieve the reception beam scanning, for example. Thus, the joint beam scanning is performed in a cooperative manner of all terminal devices (equivalent to one terminal device as a whole). For example, a set of beam directions of reception beams used by all terminal devices in the terminal device group may cover all or the whole directions of reception beams used by one terminal device to independently achieve the reception beam scanning. Accordingly, it is beneficial to saving signaling overhead, power consumption and/or time, etc. during beam scanning.

Reception beams used by the terminal device in the terminal device group may be indicated or determined by scanning beam information. Scanning beam information of all terminal devices in the terminal device group may be provided by a maker of a joint beam scanning strategy, and the information indicates one or more reception beams used by the terminal device. Preferably, a set of beam directions of reception beams indicated by scanning beam information of all terminal devices in the terminal device group may cover all or the whole directions of reception beams used by one terminal device to independently achieve the reception beam scanning.

In an embodiment, as the network side device, the electronic device 1300 itself may be the maker of the joint beam scanning strategy: At this time, for each of the terminal devices in the terminal device group, the electronic device 1300 may, for example, provide scanning beam information indicating one or more reception beams to the terminal device via the transceiver unit 510, and obtain a measurement result (such as RSRP) of the downlink reference signal such as the CSI-RS signal received by using the indicated one or more reception beams from the terminal device. The electronic device 1300 may, for example, further determine an optimal reception beam based on the obtained measurement result via the control unit 1320. For example, the optimal reception beam may be a reception beam corresponding to a best measurement result (e.g., a highest RSRP). Alternatively, the electronic device 1300 may, for example, further transmit optimal beam information to each of the terminal devices in the terminal device group via the transceiver unit 1310 to indicate the determined optimal reception beam. More specifically, in an example, as the maker of the joint beam scanning strategy, the electronic device 1300 determines and provides scanning beam information to all terminal devices in the terminal device group. Alternatively, after receiving the scanning beam information, the current terminal device in the terminal device group may transmit an acknowledgement message to the electronic device 1300, or one terminal device in the terminal device group may transmit an acknowledgement message to the electronic device 1300 on behalf of the group. After receiving the acknowledgement message, the electronic device 1300 transmits the downlink reference signal such as the CSI-RS signal using the transmission beam. Thereafter, for each of the terminal devices in the terminal device group, the terminal device may measure the downlink reference signal such as the CSI-RS signal received using the reception beams based on an indication of the scanning beam information, and report a measurement result (such as RSRP) to the electronic device 1300. The electronic device 1300 may determine an optimal reception beam based on the obtained measurement result by each of the terminal devices, and optionally transmit optimal beam information indicating the determined optimal reception beam to each of the terminal devices.

Alternatively, the maker of the joint beam scanning strategy may be a first terminal device in the terminal device group. At this time, for example, there is direct communication, such as sidelink, between the terminal devices in the terminal device group. The terminal devices in the group may negotiate through the direct communication, and for example, the first terminal device therein is the maker of the joint beam scanning strategy. The first terminal device may determine and provide scanning beam information to other terminal devices, and it may also obtain a measurement result by each of the terminal devices and determine an optimal reception beam. In this case, the electronic device 1300 does not need to provide scanning beam information to the terminal devices in the terminal device group or determine the optimal beam, but only needs to use the transmission beam to transmit the downlink reference signal such as the CSI-RS signal to the terminal devices.

In addition, according to an alternative preferred embodiment, due to beam consistency; the electronic device 1300 may also interact with the terminal devices in the terminal device group to enable them to perform a joint beam scanning on the transmission beams cooperatively, to determine an optimal transmission beam of the terminal devices and correspondingly determine an optimal reception beam of the terminal devices.

According to the alternative embodiment, for each of the terminal devices in the terminal device group, the transceiver unit 1310 of the electronic device 1300 may receive an uplink reference signal, such as an SRS signal, transmitted using one or more transmission beams from the terminal device under the control of the control unit 520 to perform a joint beam scanning on the transmission beams of the uplink reference signal. Here, the one or more transmission beams used by the terminal device are different from a transmission beam used by at least another terminal device in the terminal device group to transmit the uplink reference signal. Preferably, the difference of the transmission beams includes the difference of beam directions.

In this way, a set of transmission beams used by the uplink reference signal received by the electronic device 1300 from the terminal devices in the terminal device group may be, for example, preferably equivalent to transmission beams used by one terminal device to independently achieve the transmission beam scanning. Thus, the joint beam scanning is performed in a cooperative manner of all terminal devices (equivalent to one terminal device as a whole). For example, a set of beam directions of transmission beams used by all terminal devices in the terminal device group may cover all or the whole directions of transmission beams used by one terminal device to independently achieve the transmission beam scanning. Accordingly, it is beneficial to saving signaling overhead, power consumption and/or time, etc. during beam scanning.

Similar to the previously described preferred embodiment, in the alternative embodiment, transmission beams used by all terminal devices in the terminal device group may be indicated or determined by scanning beam information. In an example, as the network side device, the electronic device 1300 itself may be the maker of the joint beam scanning strategy: At this time, for each of the terminal devices in the terminal device group, the electronic device 1300 may, for example, provide scanning beam information indicating one or more transmission beams to the terminal device via the transceiver unit 510.

Alternatively, the electronic device 1300 may, for example, further determine an optimal transmission beam based on the uplink reference signal such as the SRS signal received from each of the terminal devices in the terminal device group and transmitted using the transmission beam via the control unit 1320. Here, the electronic device 1300 may, for example, receive SRS signals transmitted by all terminal devices using their respective transmission beams by using the reception beam in the initial beam pair or a reception beam determined after the previous beam is adjusted (for example, a reception beam corresponding to the initial transmission beam or the previously determined optimal transmission beam in the downlink transmission scene), and measure these SRS signals to determine an optimal transmission beam based on obtained measurement results (for example, RSRP). For example, a transmission beam corresponding to an optimal measurement result (e.g., a highest RSRP) may be determined as the optimal transmission beam. Moreover, the electronic device 1300 may, for example, further transmit optimal beam information indicating the determined optimal reception beam to each of the terminal devices in the terminal device group via the transceiver unit 1310. Alternatively, the maker of the joint beam scanning strategy may be a first terminal device in the terminal device group. At this time, for example, there is direct communication, such as sidelink, between the terminal devices in the terminal device group. The terminal devices in the group may negotiate through the direct communication, and for example, the first terminal device therein is the maker of the joint beam scanning strategy. The first terminal device may determine and provide scanning beam information to other terminal devices. In this case, the electronic device 1300 does not need to provide scanning beam information to the terminal devices in the terminal device group, but still needs to receive the uplink reference signal such as the SRS signal and determine the optimal beam. In addition, optionally, the electronic device 1300 obtains the joint beam scanning strategy (e.g., scanning beam information of each of the terminal devices) from the first terminal device.

As mentioned above, due to beam consistency, after the optimal transmission beam of all terminal devices in the terminal device group is determined in a manner according to the alternative embodiment, a reception beam corresponding thereto may be determined as an optimal reception beam of all terminal devices.

The preferred and alternative embodiments of the joint beam scanning that may be performed by the electronic device 1300 according to the embodiment of the present disclosure have been described above. With the above embodiments, the electronic device may interact with all terminal devices in the terminal device group, so that these terminal devices may use at least partially different (e.g., with different beam directions) transmission beams or reception beams to transmit or receive reference signals for beam management, so that, for example, it seems as if one terminal device uses all these transmission beams or reception beams to transmit or receive reference signals as a whole to achieve the joint beam scanning, thereby saving signaling overhead, power consumption and/or time, etc. during beam scanning.

In the above embodiments, multiple reception beams or transmission beams used by all terminal devices in the terminal device group are regarded as being equivalent to multiple reception beams or transmission beams used by a single terminal device, to perform joint beam scanning processing. Considering the accuracy of joint beam scanning, it is expected that reception beams of all terminal devices in the terminal device group should be aligned with each other as much as possible, so as to be suitable for being equivalent to or substituted for each other.

However, in reality, even if beam patterns of two adjacent terminal devices in the terminal device group are exactly the same, beam directions of each other may not be completely aligned due to installation and other reasons. For example, there is a case in which beam directions (for example, beam directions of reception beams) of adjacent terminal devices UE1 and UE2 are not completely aligned in the example described above with reference to FIG. 12.

Therefore, according to a further preferred embodiment, beam alignment processing may be performed in advance before joint beam scanning processing, so that beam directions of the terminal devices may be aligned, thereby improving the accuracy of the joint beam scanning processing.

More specifically, according to a further preferred embodiment, before performing the joint beam scanning, the electronic device 1300 may, for example, transmit a downlink reference signal such as a CSI-RS signal to terminal devices in a terminal device group using a transmission beam, such as via the transceiver unit 1310, and receive an uplink reference signal such as an SRS signal transmitted by the terminal devices in directions of reception beams. Due to beam consistency, in actual processing, the terminal devices may transmit the SRS signal using transmission beams corresponding to the reception beams. The electronic device 1300 may, for example, further determine beam adjustment information based on the uplink reference signal received from a current terminal device via the control unit 1320, and for example, transmit the beam adjustment information to the current terminal device via the transceiver unit 1310. The beam adjustment information is used to adjust beam directions of the reception beams of the terminal device for beam alignment. Scanning beam information used in subsequent joint beam scanning processing is preferably determined based on a result of the beam alignment of each of the terminal devices in the terminal device group.

Preferably, via the interaction between the electronic device 1300 and each of the terminal devices in the terminal device group, each of the terminal devices in the terminal device group performs the above beam alignment processing, and beam directions of reception beams of each of the terminal devices may be aligned based on requirements of the electronic device 1300 on the network side, to correct a deviation among the beam directions of the reception beams of different terminal devices. On the basis that the deviation among the beam directions of the reception beams of each of the terminal devices in the terminal device group is corrected, a set of the beam directions of the reception beams of the terminal devices indicated by the determined scanning beam information of the terminal devices may be exactly equivalent to a set of beam directions of reception beams of a single terminal device (for example, to cover a complete scanning range).

On the other hand, after each of the terminal devices in the terminal device group performs the above beam alignment processing via the interaction between the electronic device 1300 and each of the terminal devices in the terminal device group, although the beam directions of the reception beams of each of the terminal devices are aligned based on the requirements of the electronic device 130 on the network side, there is still a certain deviation among the beam directions of the reception beams of different terminal devices. At this time, the electronic device 1300 as a maker of a joint beam scanning strategy may correct (relatively calibrate) the beam directions of the reception beams of different terminal devices by itself on the basis of this deviation in a case of making the scanning strategy or determining the scanning beam information, so that a set of the beam directions of the reception beams of the terminal devices indicated by the finally determined scanning beam information of the terminal devices may be exactly equivalent to a set of beam directions of reception beams of a single terminal device (for example, to cover a complete scanning range).

As an example, optionally, the above beam alignment processing that the electronic device 1300 causes the terminal device in the terminal device group to perform may be started by, for example, first transmitting a beam alignment indication message to the terminal device in the terminal device group via the transceiver unit 1310. In the non-terrestrial Internet of Things application, the electronic device 1300 may simultaneously transmit beam alignment indication messages to all terminal devices in the terminal device group, which may include, for example, scheduled time for carrying out beam alignment, and may optionally further include a setting of a reception antenna, a frequency, a satellite ID, ephemeris or ephemeris information of a satellite (in a case that the terminal devices do not know the ephemeris or ephemeris information in advance) and the like. After receiving the message, each of the terminal devices in the terminal device group may transmit an acknowledgement message to the network side as a reply.

Thereafter, at the scheduled time indicated by the beam alignment indication message, the electronic device 1300 transmits a downlink reference signal such as a CSI-RS signal using a transmission beam to a geographical position direction of the terminal device group. The terminal devices in the terminal device group may perform omni-directional beam scanning with a satellite direction as a center based on the beam alignment indication message, for example, according to the ephemeris (ephemeris information) of the satellite included in the beam alignment indication message, and may transmit the SRS signal in beam directions of the reception beams (for example, the beam directions with certain angular intervals from each other). The electronic device 1300 receives the SRS signal of the terminal devices in the terminal device group, evaluates uplink channels of the terminal devices based on the received SRS signal, for example, to generate adjustment parameters of beam alignment of the terminal devices based on a result of channel evaluation, and transmits beam adjustment information indicating the adjustment parameters to the terminal devices. For example, the electronic device 1300 may generate the above adjustment parameters based on the result of channel evaluation by using the existing beamforming technology, which is not described here.

The terminal devices in the terminal device group may receive the beam adjustment information from the network side device, and adjust beam directions of the reception beams to be used based on the beam adjustment information for beam alignment. After completing the adjustment, the terminal devices in the terminal device group may, for example, transmit a completion message to the network side device, which may, for example, include adjusted beam directions of the reception beams.

The further preferred embodiments of processing in which the electronic device 1300 may interact with the terminal devices in the terminal device group to perform the joint beam scanning have been described above. With the preferred embodiments, the beam alignment processing may be performed in advance before the joint beam scanning processing, so that the beam directions of the terminal devices may be aligned, thereby improving the accuracy of the joint beam scanning processing. However, those skilled in the art may understand that the beam alignment processing is not necessary. Due to the similarity of channel characteristics among terminal devices in the terminal device group, even if the joint beam scanning processing is directly performed without the beam alignment processing, generally an acceptable beam scanning result may be obtained.

### 3.3 Example Signaling Interaction Related to a Joint Beam Scanning

On the basis of having described the example processing in which electronic devices on the user equipment side and the network side interact with each other to perform the joint beam scanning, example signaling interaction flows of preferred embodiments related to a joint beam scanning are briefly described below:

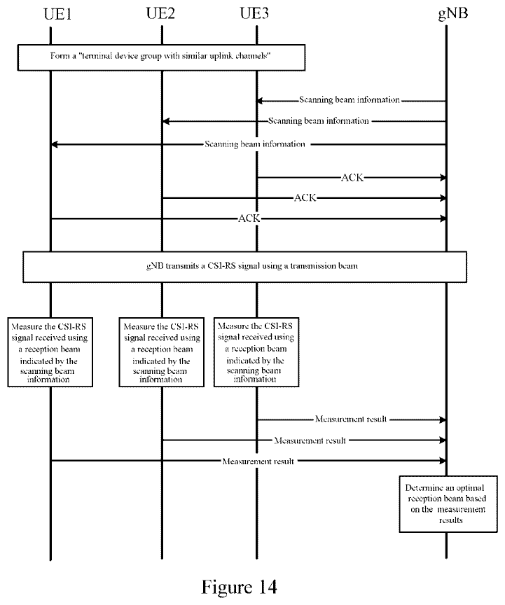

FIG. 14 is a flowchart for explaining an example of an information interaction process of a joint beam scanning that can be implemented according to a preferred embodiment of the present disclosure. An example of a joint beam scanning in a case that a network side device is a maker of a joint beam scanning strategy is shown. An example signaling flow in which a network side device gNB (which may be implemented by the electronic device 1300 or have the function of the electronic device 1300 described with reference to FIG. 13) interacts with terminal devices UE1, UE2 and UE3 (which may be implemented by the electronic device 500 or have the function of the electronic device 500 described above with reference to FIG. 5, for example) in a terminal device group is shown.

As shown in FIG. 14, the terminal devices UE1, UE2 and UE3 form a terminal device group with similar uplink channels. Thereafter, the network side device gNB provides the terminal devices UE1, UE2 and UE3 with scanning beam information indicating one or more reception beams. After receiving the scanning beam information, the terminal devices UE1, UE2 and UE3 transmit acknowledgement messages ACK to the network side device gNB, respectively. After receiving the acknowledgement messages, the network side device gNB transmits a CSI-RS signal using a transmission beam. The terminal devices UE1, UE2 and UE3 perform a joint beam scanning based on the scanning beam information. That is, UE1, UE2 and UE3 respectively measure the CSI-RS signal received using the reception beams indicated by the scanning beam information. Thereafter, UE1, UE2 and UE3 report their measurement results (such as RSRP) to the network side device gNB. The network side device gNB determines an optimal reception beam based on these measurement results, and optionally transmits optimal beam information to each of the terminal devices (not shown in FIG. 14).

In the example shown in FIG. 14, after receiving the scanning beam information, the terminal devices UE1, UE2 and UE3 each transmit an acknowledgement message to the network side device gNB. In an alternative example, one terminal device UE1 may transmit a group acknowledgement message to the network side device gNB as a representative, which is not repeated here.

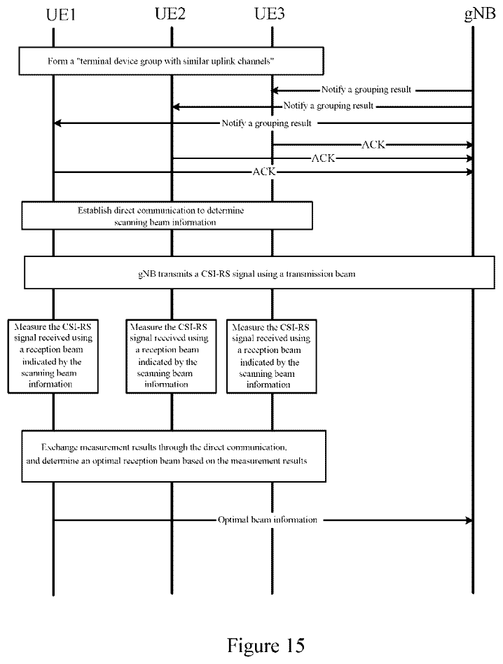

FIG. 15 is a flowchart for explaining an example of an information interaction process of a joint beam scanning that can be implemented according to another preferred embodiment of the present disclosure. An example of a joint beam scanning in a case that a terminal device itself in a terminal device group is a maker of a joint beam scanning strategy. An example signaling flow in which a network side device gNB (which may be implemented by the electronic device 1300 or have the function of the electronic device 1300 described with reference to FIG. 13) interacts with terminal devices UE1, UE2 and UE3 (which may be implemented by the electronic device 500 or have the function of the electronic device 500 described above with reference to FIG. 5, for example) in a terminal device group is shown.

As shown in FIG. 15, the terminal devices UE1, UE2 and UE3 form a terminal device group with similar uplink channels. Thereafter, for example, the network side device gNB notifies the terminal devices UE1, UE2 and UE3 of a grouping result, for example, provides member information related to members of the terminal device group with the similar uplink channels. After receiving the notification of the grouping result, the terminal devices UE1, UE2 and UE3 transmit acknowledgement messages ACK to the network side device gNB, respectively. Thereafter, the terminal devices UE1, UE2 and UE3 establish direct communication to negotiate a beam scanning strategy, and for example, UE1 therein finally determines and provides scanning beam information to UE2 and UE3. Next, the network side device gNB transmits a CSI-RS signal using a transmission beam. For the CSI-RS signal, the terminal devices UE1, UE2 and UE3 perform a joint beam scanning based on the scanning beam information. That is, UE1, UE2 and UE3 respectively measure the CSI-RS signal received using reception beams indicated by the scanning beam information. Thereafter, UE1, UE2 and UE3 exchange their measurement results (such as RSRP) with each other via the direct communication, and UE1 therein determines an optimal reception beam based on these measurement results. Alternatively, for example, UE1 therein transmits optimal beam information to the network side device gNB.

In an alternative example, after UE1, UE2 and UE3 exchange their respective measurement results (such as RSRP) with each other via the direct communication, for example, UE1 therein may report these measurement results to the network side device gNB, and the network side device gNB may determine an optimal reception beam accordingly.

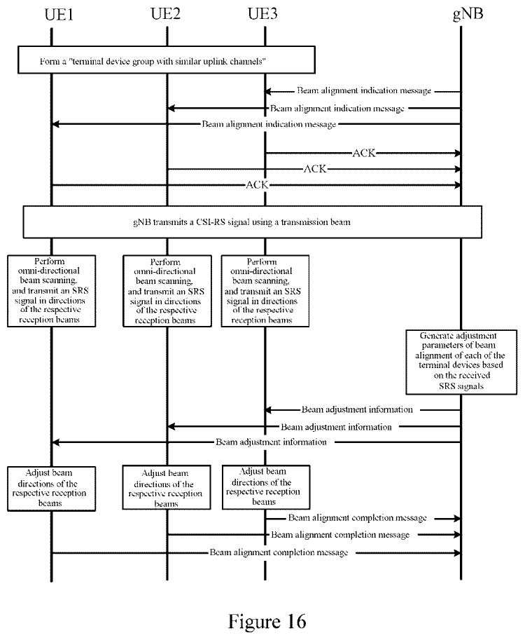

FIG. 16 is a flowchart for explaining an example of an information interaction process of beam alignment processing that can be implemented according to a preferred embodiment of the present disclosure. An example of beam alignment processing according to a further preferred embodiment is shown. An example signaling interaction between a network side device gNB (which may be implemented by the electronic device 1300 or have the function of the electronic device 1300 described with reference to FIG. 13) and terminal devices UE1, UE2 and UE3 (which may be implemented by the electronic device 500 or have the function of the electronic device 500 described above with reference to FIG. 5, for example) in a terminal device group is shown.

As shown in FIG. 16, the terminal devices UE1, UE2 and UE3 form a terminal device group with similar uplink channels. Thereafter, the network side device gNB simultaneously transmits beam alignment indication messages to the terminal devices UE1, UE2 and UE3. The beam alignment indication message may include, for example, scheduled time for carrying out beam alignment, and may optionally further include a setting of a reception antenna, a frequency, a satellite ID, ephemeris or ephemeris information of a satellite (in a case that the terminal devices do not know the ephemeris or ephemeris information in advance) and the like. After receiving the information, the terminal devices UE1, UE2 and UE3 respectively transmit acknowledgement messages ACK to the network side device gNB as a reply.

Thereafter, at the scheduled time indicated by the beam alignment indication message, the network side device gNB transmits a CSI-RS signal to a geographical position direction of the terminal device group using a transmission beam. The terminal devices UE1, UE2, and UE3 respectively perform omni-directional beam scanning with a satellite direction as a center based on the beam alignment indication message, for example, according to the ephemeris (ephemeris information) of the satellite included in the beam alignment indication message, and may transmit SRS signals in beam directions of reception beams (for example, the beam directions with certain angular intervals from each other). The network side device gNB receives these SRS signals, and evaluates uplink channels of the terminal devices based on the received SRS signals, for example, to generate adjustment parameters of beam alignment of the terminal devices based on a result of channel evaluation. Thereafter, the network side device gNB transmits beam adjustment information indicating the adjustment parameters to the terminal devices UE1, UE2 and UE3.

The terminal devices UE1, UE2 and UE3 may respectively adjust beam directions of the reception beams to be used based on the received beam adjustment information for beam alignment. After completing the adjustment, the terminal devices UE1, UE2 and UE3 may transmit beam alignment completion messages to the network side device.

It is to be noted that, the example of the beam alignment such as in FIG. 16 may be performed before the joint beam scanning process of FIGS. 14 and 15, that is, after the terminal device group has been formed and before the joint beam scanning process, to improve the accuracy of the joint beam scanning.

### 4. Method Embodiments

Corresponding to the above device embodiments, the following method embodiments are provided according to the present disclosure.

First, a wireless communication method performed by an electronic device on a terminal device side (that is, the electronic device 500) according to an embodiment of the present disclosure is described.

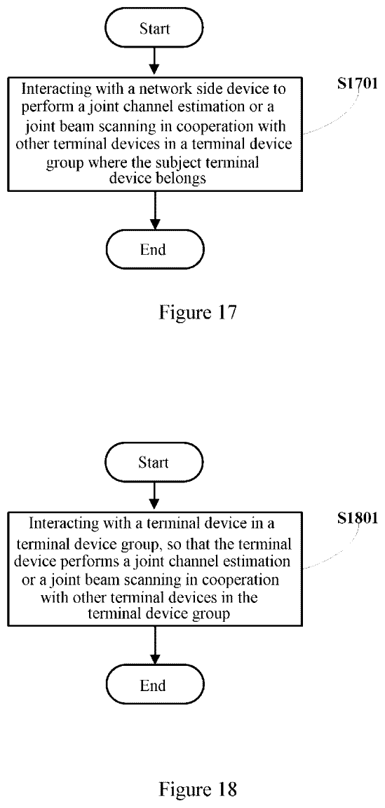

FIG. 17 is a flowchart showing a process example of a wireless communication method on a terminal device side according to an embodiment of the present disclosure.

As shown in FIG. 17, step S1701 includes interacting with a network side device to perform a joint channel estimation or a joint beam scanning in cooperation with other terminal devices in a terminal device group where the terminal device belongs. Here, all terminal devices in the terminal device group have similar channel characteristics.

In a preferred embodiment, in step S1701, a reference signal for a channel estimation is transmitted or received based on a time resource and/or a frequency resource indicated by the network side device to perform the joint channel estimation, where the time resource and/or the frequency resource are different from a resource of the reference signal transmitted or received by at least another terminal device in the terminal device group.

Optionally, the time resource indicated by the network side device is different from a time resource of the reference signal transmitted or received by other terminal devices in the terminal device group.

In addition, optionally, the time resource indicated by the network side device is the same as a time resource of the reference signal transmitted or received by a first terminal device in the terminal device group, and different from a time resource of the reference signal transmitted or received by a second terminal device in the terminal device group.

In addition, optionally, although not shown in FIG. 17, the method may further include: reporting a battery energy level of the electronic device to the network side device. At this time, time indicated by the time resource corresponds to the number of times that the electronic device transmits or receives the reference signal, which is determined based on the battery energy level and battery energy levels of other terminal devices in the terminal device group.

Optionally, the frequency resource indicated by the network side device is in a different narrow frequency band from a frequency resource of the reference signal transmitted or received by at least another terminal device in the terminal device group.

In a preferred embodiment, in step S1701, a precoded reference signal for a channel estimation is transmitted or received based on precoding information indicated by the network side device to perform the joint channel estimation, where a phase of the reference signal is different from a phase of the reference signal transmitted or received by at least another terminal device in the terminal device group.

In a preferred embodiment, the joint channel estimation includes a downlink channel estimation, and the similar channel characteristics include similar downlink channel characteristics. In step S1701, for example, the following processing may be performed: the received reference signal is measured: for each of other terminal devices in the terminal device group, a measurement result by the terminal device for the received reference signal is obtained from other terminal devices in the terminal device group; and the downlink channel estimation is performed based on a result of measuring the received reference signal and the obtained measurement result.

In a preferred embodiment, the similar channel characteristics include similar uplink channel characteristics. In step S1701, for example, the following processing may be performed: an uplink reference signal is transmitted to the network side device by using one or more transmission beams to perform a joint beam scanning on the transmission beams of the uplink reference signal, where the one or more transmission beams are different from a transmission beam used by at least another terminal device in the terminal device group to transmit the uplink reference signal.

In the preferred embodiment, although not shown, the method may include: obtaining scanning beam information indicating the one or more transmission beams from the network side device or from other terminal devices in the terminal device group.

In the preferred embodiment, although not shown, the method may further include: receiving optimal beam information from the network side device, where the optimal beam information indicates an optimal transmission beam determined by the network side device based on the uplink reference signal received from each of the terminal devices in the terminal device group and transmitted by using the transmission beams.

In a preferred embodiment, the similar channel characteristics include similar uplink channel characteristics. In step S1701, for example, the following processing may be performed: a downlink reference signal transmitted by the network side device using a transmission beam is received by using one or more reception beams to perform a joint beam scanning on the reception beams of the downlink reference signal, where the one or more reception beams are different from a reception beam used by at least another terminal device in the terminal device group to receive the downlink reference signal.

In the preferred embodiment, although not shown, the method may further include: obtaining scanning beam information indicating the one or more reception beams from the network side device or a first terminal device in the terminal device group: and reporting a measurement result of the downlink reference signal that is received by using the one or more reception beams to the network side device or the first terminal device.

In the preferred embodiment, although not shown, the method may further include: obtaining optimal beam information from the network side device or a first terminal device, where the optimal beam information indicates an optimal reception beam determined based on a measurement result by each of the terminal devices in the terminal device group.

In the preferred embodiment, although not shown, the method may further include: for each of other terminal devices in the terminal device group, providing scanning beam information to the terminal device, where the scanning beam information indicates one or more reception beams used by the terminal device to receive the downlink reference signal; obtaining a measurement result of the downlink reference signal that is received by using the indicated one or more reception beams from the terminal device: and determining an optimal reception beam based on a measurement result by each of the terminal devices in the terminal device group.

In the preferred embodiment, although not shown, the method may further include: before the joint beam scanning, for the downlink reference signal transmitted by the network side device using the transmission beam, transmitting an uplink reference signal in directions of the reception beams: and receiving beam adjustment information determined based on the received uplink reference signal from the network side device, and adjusting beam directions of the reception beams based on the beam adjustment information for beam alignment, where the scanning beam information is determined based on a result of the beam alignment of each of the terminal devices in the terminal device group.

According to an embodiment of the present disclosure, a subject that performs the above method may be the electronic device 500 on the terminal device side according to the embodiments of the present disclosure, so all the embodiments regarding the electronic device 500 are applicable herein.

A wireless communication method performed by an electronic device on a network side (that is, the electronic device 1300) according to an embodiment of the present disclosure is described in detail below.

FIG. 18 is a flowchart showing a process example of a wireless communication method on a network side according to an embodiment of the present disclosure.

As shown in FIG. 18, step S1801 includes interacting with a terminal device in a terminal device group, where the terminal device performs a joint channel estimation or a joint beam scanning in cooperation with other terminal devices in the terminal device group, where all terminal devices in the terminal device group have similar channel characteristics.

In a preferred embodiment, in step S1801, a time resource and/or a frequency resource of a reference signal for a channel estimation may be indicated to the terminal device, where the terminal device transmits or receives the reference signal based on the time resource and/or the frequency resource to perform the joint channel estimation, and where the time resource and/or the frequency resource are different from a resource of the reference signal transmitted or received by at least another terminal device in the terminal device group.

Optionally, the time resource indicated to the terminal device is different from a time resource of the reference signal transmitted or received by other terminal devices in the terminal device group.

In addition, optionally, the time resource indicated to the terminal device is the same as a time resource of the reference signal transmitted or received by a first terminal device in the terminal device group, and different from a time resource of the reference signal transmitted or received by a second terminal device in the terminal device group.

In addition, optionally, although not shown in FIG. 18, the method may further include: for each of the terminal devices in the terminal device group, receiving a battery energy level reported by the terminal device. At this time, the number of times that the terminal device transmits or receives the reference signal is determined based on the received battery energy level, and the time resource indicating time corresponding to the number of times is determined.

Optionally, the frequency resource indicated to the terminal device is in a different narrow frequency band from a frequency resource of the reference signal transmitted or received by at least another terminal device in the terminal device group.

In a preferred embodiment, in step S1801, precoding information is indicated to the terminal device, where the terminal device transmits or receives a precoded reference signal for a channel estimation based on the precoding information to perform the joint channel estimation, where a phase of the reference signal is different from a phase of the reference signal transmitted or received by at least another terminal device in the terminal device group.

In a preferred embodiment, the joint channel estimation includes an uplink channel estimation, and the similar channel characteristics include similar uplink channel characteristics. In step S1801, the following processing may be performed: for each of the terminal devices in the terminal device group, the reference signal received from the terminal device is measured: and the uplink channel estimation is performed based on measurement results.

In a preferred embodiment, the similar channel characteristics include similar uplink channel characteristics. In step S1801, the following processing may be performed: for each of the terminal devices in the terminal device group, an uplink reference signal transmitted using one or more transmission beams is received from the terminal device to perform a joint beam scanning on the transmission beams of the uplink reference signal, where a transmission beam of the terminal device is different from a transmission beam used by at least another terminal device in the terminal device group to transmit the uplink reference signal.

In the preferred embodiment, although not shown in FIG. 18, the method may further include: transmitting scanning beam information indicating the one or more transmission beams to each of the terminal devices in the terminal device group.

In the preferred embodiment, although not shown in FIG. 18, the method may further include: determining an optimal transmission beam based on the uplink reference signal received from each of the terminal devices in the terminal device group and transmitted using the transmission beams: and transmitting optimal beam information indicating the optimal transmission beam to each of the terminal devices in the terminal device group.

In a preferred embodiment, the similar channel characteristics include similar uplink channel characteristics. In step S1801, the following processing may be performed: a downlink reference signal is transmitted to the terminal device in the terminal device group by using a transmission beam, where the terminal device receives the downlink reference signal by using one or more reception beams to perform a joint beam scanning on the reception beams of the downlink reference signal, where the one or more reception beams are different from a reception beam used by at least another terminal device in the terminal device group to receive the downlink reference signal.

In the preferred embodiment, although not shown in FIG. 18, the method may further include: for each of the terminal devices in the terminal device group, providing scanning beam information indicating one or more reception beams to the terminal device:

obtaining, from the terminal device, a measurement result of the downlink reference signal that is received by using the indicated one or more reception beams: and determining an optimal reception beam based on the obtained measurement result.

In the preferred embodiment, although not shown in FIG. 18, the method may further include: before the joint beam scanning, transmitting the downlink reference signal to the terminal device by using the transmission beam, and receiving an uplink reference signal transmitted by the terminal device in directions of the reception beams: and transmitting beam adjustment information determined based on the received uplink reference signal to the terminal device, where the beam adjustment information is used to adjust beam directions of the reception beams of the terminal device for beam alignment: and where the scanning beam information is determined based on a result of the beam alignment of each of the terminal devices in the terminal device group.

According to an embodiment of the present disclosure, a subject that performs the above method may be the electronic device 1300 according to the embodiments of the present disclosure, so all the previous embodiments regarding the electronic device 1300 are applicable herein.

### 5. Application Example

The technology of the present disclosure is applicable to various products.

For example, the electronic device 1300 on the network side may be implemented as any type of base station device, such as a macro eNB and a small eNB, and may be implemented as any type of gNB (a base station in a 5G system). The small eNB may be an eNB covering a cell smaller than a macro cell, such as a pico eNB, a micro eNB, or a home (femto) eNB. Alternatively, the base station may be implemented as any other type of base station, such as a NodeB and a base transceiver station (BTS). The base station may include a body (which is also referred to as a base station device) configured to control wireless communication and one or more remote radio heads (RRHs) that are arranged in a different place from the body.

In addition, the electronic device 1300 on the network side may also be implemented as any type of TRP. The TRP may have functions of transmitting and receiving, for example, the TRP may receive information from the user equipment and the base station device, and may also transmit information to the user equipment and the base station device. In a typical example, the TRP may serve the user equipment and be controlled by the base station device. Further, the TRP may have a structure similar to that of the base station device, or may only have the structure related to transmitting and receiving information in the base station device.

The electronic device 500 on the terminal device side may be various user equipment, which may be implemented as a mobile terminal (such as a smartphone, a tablet personal computer (PC), a notebook PC, a portable game terminal, a portable/dongle-type mobile router, and a digital camera), or an in-vehicle terminal (such as a car navigation device). The user equipment may also be implemented as a terminal that performs machine-to-machine (M2M) communication (which is also referred to as a machine type communication (MTC) terminal). In addition, the user equipment may be a wireless communication module (such as an integrated circuit module including a single wafer) installed on each of the user equipment described above. In addition, the electronic device 500 may also be various terminal devices in the non-terrestrial Internet of Things.

### Application Examples of a Base Station

### First Application Example

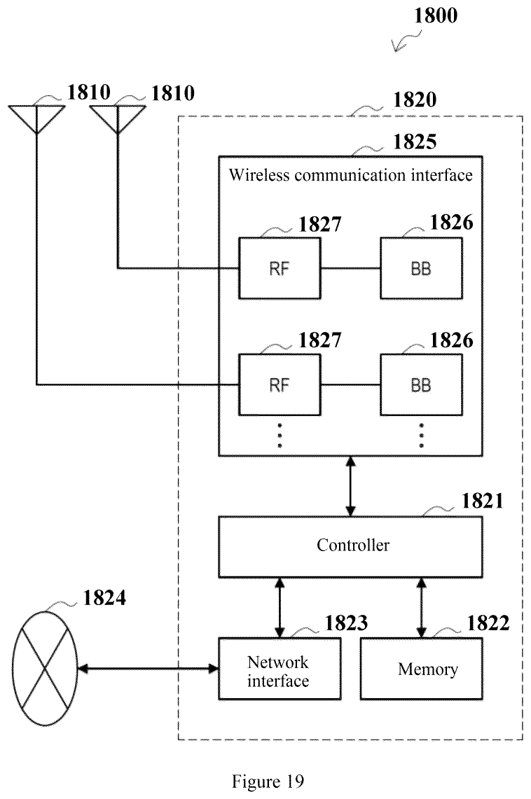

FIG. 19 is a block diagram showing a first example of a schematic configuration of an eNB to which the technology of the present disclosure may be applied. The eNB 1800 includes a single or multiple antennas 1810 and a base station device 1820. The base station device 1820 and each of the antennas 1810 may be connected to each other via an RF cable.

Each of the antennas 1810 includes a single or multiple antenna elements (such as multiple antenna elements included in a multiple-input multiple-output (MIMO) antenna), and is used for the base station device 1820 to transmit and receive wireless signals. The eNB 1800 may include multiple antennas 1810, as shown in FIG. 19. For example, the multiple antennas 1810 may be compatible with multiple frequency bands used by the eNB 1800. Although FIG. 19 shows an example in which the eNB 1800 includes multiple antennas 1810, the eNB 1800 may include a single antenna 1810.

The base station device 1820 includes a controller 1821, a memory 1822, a network interface 1823, and a wireless communication interface 1825.

The controller 1821 may be, for example, a CPU or a DSP, and operates various functions of a higher layer of the base station device 1820. For example, the controller 1821 generates a data packet based on data in a signal processed by the wireless communication interface 1825, and transfers the generated packet via the network interface 1823. The controller 1821 may bundle data from multiple baseband processors to generate a bundled packet, and transfer the generated bundled packet. The controller 1821 may have logical functions of performing control such as radio resource control, radio bearer control, mobility management, admission control, and scheduling. The control may be performed in conjunction with an adjacent eNB or a core network node. The memory 1822 includes an RAM and an ROM, and stores a program executed by the controller 1821, and various types of control data (such as a terminal list, transmission power data, and scheduling data).

The network interface 1823 is a communication interface for connecting the base station device 1820 to a core network 1824. The controller 1821 may communicate with a core network node or another eNB via the network interface 1823. In this case, the eNB 1800, and the core network node or the other eNB may be connected to each other through a logical interface (such as an SI interface and an X2 interface). The network interface 1823 may also be a wired communication interface or a wireless communication interface for a wireless backhaul line. In a case that the network interface 1823 is a wireless communication interface, the network interface 1823 may use a higher frequency band for wireless communication than a frequency band used by the wireless communication interface 1825.

The wireless communication interface 1825 supports any cellular communication scheme (such as Long Term Evolution (LTE) and LTE-Advanced), and provides wireless connection to a terminal positioned in a cell of the eNB 1800 via the antenna 1810. The wireless communication interface 1825 may typically include, for example, a baseband (BB) processor 1826 and a RF circuit 1827. The BB processor 1826 may perform, for example, encoding/decoding, modulating/demodulating and multiplexing/de-multiplexing, and perform various types of signal processes of layers (for example, LI, media access control (MAC), radio link control (RLC) and packet data convergence protocol (PDCP)). Instead of the controller 1821, the BB processor 1826 may have a part or all of the above logical functions. The BB processor 1826 may be a memory storing a communication control program, or a module including a processor and a related circuit configured to execute the program. Updating the program may change the functions of the BB processor 1826. The module may be a card or a blade inserted into a slot of the base station device 1820. Alternatively, the module may also be a chip mounted on the card or the blade. In addition, the RF circuit 1827 may include, for example, a frequency mixer, a filter and an amplifier, and transmit and receive wireless signals via the antenna 1810.

As shown in FIG. 19, the wireless communication interface 1825 may include multiple BB processors 1826. For example, the multiple BB processors 1826 may be compatible with multiple frequency bands used by the eNB 1800. As shown in FIG. 19, the wireless communication interface 1825 may include multiple RF circuits 1827. For example, the multiple RF circuits 1827 may be compatible with multiple antenna elements. Although FIG. 19 shows an example in which the wireless communication interface 1825 includes multiple BB processors 1826 and multiple RF circuits 1827, the wireless communication interface 1825 may include a single BB processor 1826 or a single RF circuit 1827.

In the eNB 1800 shown in FIG. 19, the transceiver unit 1310 in the electronic device 1300 described above with reference to FIG. 13 may be implemented by the wireless communication interface 1825 and the optional antenna 1810. The function of the control unit 1320 in the electronic device 1300 may be implemented by the controller 1821 and the function of the storage unit 1330 may be implemented by the memory 1822. For example, the controller 1821 may implement the function of the control unit 1320 by executing instructions stored in the memory 1822.

### Second Application Example

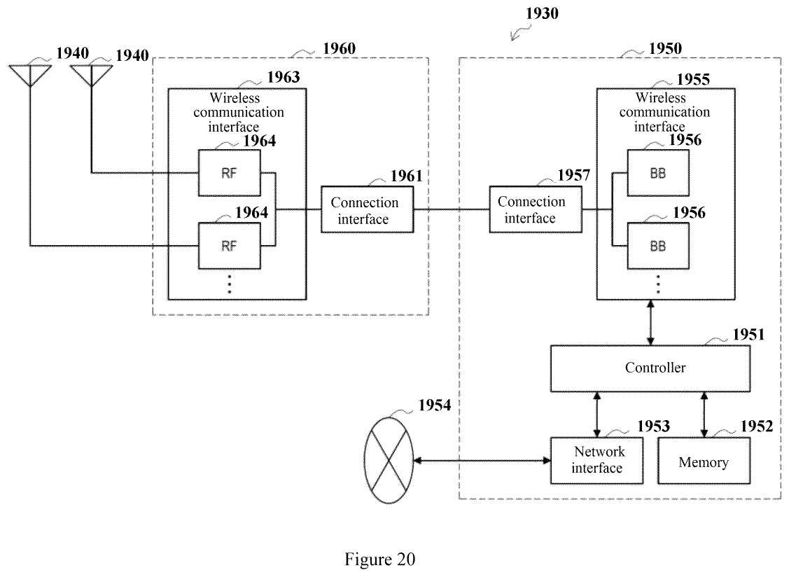

FIG. 20 is a block diagram showing a second example of a schematic configuration of an eNB to which the technology of the present disclosure may be applied. The eNB 1930 includes a single or multiple antennas 1940, a base station device 1950 and an RRH 1960. The RRH 1960 and each antenna 1940 may be connected to each other via an RF cable. The base station device 1950 and the RRH 1960 may be connected to each other via a high-speed line such as an optical fiber cable.

Each of the antennas 1940 includes a single or multiple antenna elements (such as multiple antenna elements included in an MIMO antenna), and is used for the RRH 1960 to transmit and receive wireless signals. As shown in FIG. 20, the eNB 1930 may include multiple antennas 1940. For example, the multiple antennas 1940 may be compatible with multiple frequency bands used by the eNB 1930. Although FIG. 20 shows an example in which the eNB 1930 includes multiple antennas 1940, the eNB 1930 may include a single antenna 1940.

The base station device 1950 includes a controller 1951, a memory 1952, a network interface 1953, a wireless communication interface 1955, and a connection interface 1957. The controller 1951, the memory 1952, and the network interface 1953 are the same as the controller 1821, the memory 1822, and the network interface 1823 described with reference to FIG. 19.

The wireless communication interface 1955 supports any cellular communication scheme (such as LTE and LTE-advanced), and provides wireless communication with a terminal located in a sector corresponding to the RRH 1960 via the RRH 1960 and the antenna 1940. The wireless communication interface 1955 may typically include, for example, a BB processor 1956. The BB processor 1956 is the same as the BB processor 1826 described with reference to FIG. 19, except that the BB processor 1956 is connected to a RF circuit 1964 of the RRH 1960 via the connection interface 1957. As shown in FIG. 20, the wireless communication interface 1955 may include multiple BB processors 1956. For example, the multiple BB processors 1956 may be compatible with multiple frequency bands used by the eNB 1930. Although FIG. 20 shows an example in which the wireless communication interface 1955 includes multiple BB processors 1956, the wireless communication interface 1955 may include a single BB processor 1956.

The connection interface 1957 is an interface for connecting the base station device 1950 (the wireless communication interface 1955) to the RRH 1960. The connection interface 1957 may also be a communication module for communication in the above high-speed line that connects the base station device 1950 (the wireless communication interface 1955) to the RRH 1960.

The RRH 1960 includes a connection interface 1961 and a wireless communication interface 1963.

The connection interface 1961 is an interface for connecting the RRH 1960 (the wireless communication interface 1963) to the base station device 1950. The connection interface 1961 may also be a communication module for communication in the above high-speed line.

The wireless communication interface 1963 transmits and receives wireless signals via the antenna 1940. The wireless communication interface 1963 may typically include, for example, the RF circuit 1964. The RF circuit 1964 may include, for example, a frequency mixer, a filter and an amplifier, and transmit and receive wireless signals via the antenna 1940. The wireless communication interface 1963 may include multiple RF circuits 1964, as shown in FIG. 20. For example, the multiple RF circuits 1964 may support multiple antenna elements. Although FIG. 20 shows an example in which the wireless communication interface 1963 includes multiple RF circuits 1964, the wireless communication interface 1963 may include a single RF circuit 1964.

In the eNB 1930 shown in FIG. 20, the transceiver unit 1310 in the electronic device 1300 described above with reference to FIG. 13 may be implemented, for example, by the wireless communication interface 1963 and the optional antenna 1940. The function of the control unit 1320 in the electronic device 1300 may be implemented by the controller 1951 and the function of the storage unit 1330 may be implemented by the memory 1952. For example, the controller 1951 may implement the function of the control unit 1320 by executing instructions stored in the memory 1952.

### Application Examples of a User Equipment

### First Application Example

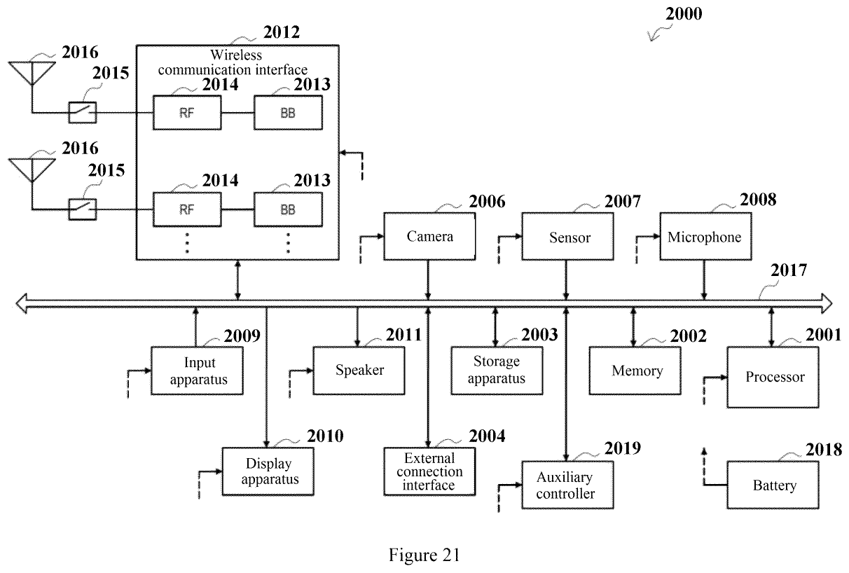

FIG. 21 is a block diagram showing an example of a schematic configuration of a smartphone 2000 to which the technology of the present disclosure may be applied. The smartphone 2000 includes a processor 2001, a memory 2002, a storage apparatus 2003, an external connection interface 2004, a camera 2006, a sensor 2007, a microphone 2008, an input apparatus 2009, a display apparatus 2010, a speaker 2011, a wireless communication interface 2012, one or more antenna handovers 2015, one or more antennas 2016, a bus 2017, a battery 2018 and an auxiliary controller 2019.

The processor 2001 may be, for example, a CPU or a system on chip (SoC), and control functions of an application layer and another layer of the smartphone 2000. The memory 2002 includes an RAM and an ROM, and stores a program that is executed by the processor 2001, and data. The storage apparatus 2003 may include a storage medium such as a semiconductor memory and a hard disk. The external connection interface 2004 is an interface for connecting an external apparatus (such as a memory card and a universal serial bus (USB) apparatus) to the smartphone 2000.

The camera 2006 includes an image sensor (such as a charge coupled device (CCD) and a complementary metal oxide semiconductor (CMOS)) and generates a captured image. The sensor 2007 may include a group of sensors, such as a measurement sensor, a gyroscope sensor, a geomagnetic sensor and an acceleration sensor. The microphone 2008 converts sounds that are inputted to the smartphone 2000 into audio signals. The input apparatus 2009 includes, for example, a touch sensor configured to detect touch on a screen of the display apparatus 2010, a keypad, a keyboard, a button, or a handover, and receives an operation or information inputted from a user. The display apparatus 2010 includes a screen (such as a liquid crystal display (LCD) and an organic light-emitting diode (OLED) display), and displays an output image of the smartphone 2000. The speaker 2011 converts audio signals that are outputted from the smartphone 2000 to sounds.

The wireless communication interface 2012 supports any cellular communication scheme (such as LTE and LTE-Advanced), and performs wireless communications. The wireless communication interface 2012 may typically include, for example, a BB processor 2013 and a RF circuit 2014. The BB processor 2013 may perform, for example, encoding/decoding, modulating/demodulating and multiplexing/de-multiplexing, and perform various types of signal processing for wireless communications. Meanwhile, the RF circuit 2014 may include, for example, a frequency mixer, a filter and an amplifier, and transmit and receive wireless signals via the antenna 2016. The wireless communication interface 2012 may be a chip module on which the BB processor 2013 and the RF circuit 2014 are integrated. As shown in FIG. 21, the wireless communication interface 2012 may include multiple BB processors 2013 and multiple RF circuits 2014. Although FIG. 21 shows an example in which the wireless communication interface 2012 includes multiple BB processors 2013 and multiple RF circuits 2014, the wireless communication interface 2012 may include a single BB processor 2013 or a single RF circuit 2014.

Furthermore, in addition to the cellular communication scheme, the wireless communication interface 2012 may support another type of wireless communication scheme such as a short-distance wireless communication scheme, a near field communication scheme, and a wireless local area network (LAN) scheme. In this case, the wireless communication interface 2012 may include a BB processor 2013 and a RF circuit 2014 for each wireless communication scheme.

Each of the antenna handovers 2015 handovers a connection destination of the antenna 916 among multiple circuits (such as circuits for different wireless communication schemes) included in the wireless communication interface 2012.

Each of the antennas 2016 includes a single or multiple antenna elements (such as multiple antenna elements included in an MIMO antenna), and is used for the wireless communication interface 2012 to transmit and receive wireless signals. The smartphone 2000 may include multiple antennas 2016, as shown in FIG. 21. Although FIG. 21 shows an example in which the smartphone 2000 includes multiple antennas 2016, the smartphone 2000 may include a single antenna 2016.

Furthermore, the smartphone 2000 may include an antenna 2016 for each wireless communication scheme. In this case, the antenna handover 2015 may be omitted from the configuration of the smartphone 2000.

The processor 2001, the memory 2002, the storage apparatus 2003, the external connection interface 2004, the camera 2006, the sensor 2007, the microphone 2008, the input apparatus 2009, the display apparatus 2010, the speaker 2011, the wireless communication interface 2012 and the auxiliary controller 2019 are connected to each other via the bus 2017. The battery 2018 supplies power to blocks in the smartphone 2000 shown in FIG. 21 via a feeder line which is indicated partially as a dashed line in FIG. 21. The auxiliary controller 2019 operates a minimum necessary function of the smartphone 2000 in a sleeping mode, for example.

In the smartphone 2000 shown in FIG. 21, the transceiver unit 510 in the electronic device 500 described above with reference to FIG. 5 may be implemented by the wireless communication interface 2012 and the optional antenna 2016. The function of the control unit 520 in the electronic device 500 may be implemented by the processor 2001 or the auxiliary controller 2019, and the function of the storage unit 530 may be implemented by the memory 2002. For example, the processor 2001 or the auxiliary controller 2019 may implement the function of the control unit 520 by executing instructions stored in the memory 2002 or the storage apparatus 2003.

### Second Application Example

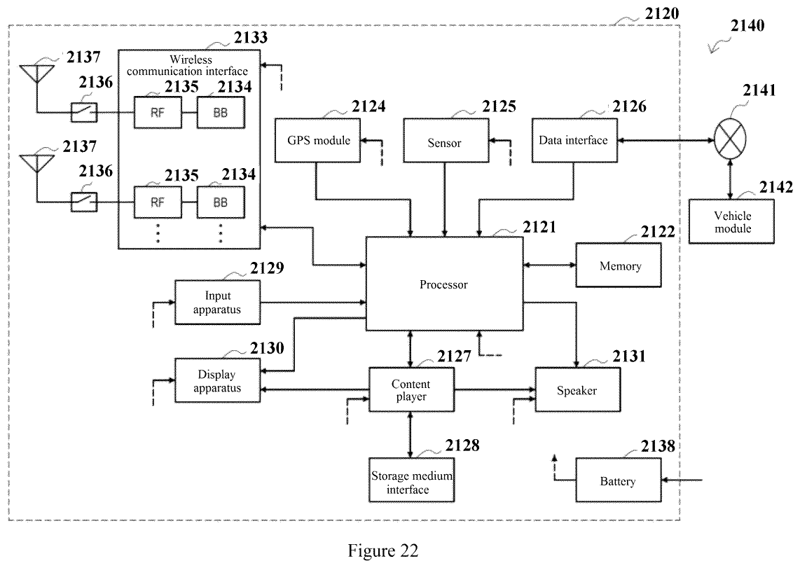

FIG. 22 is a block diagram showing an example of a schematic configuration of a car navigation device 2120 to which the technology of the present disclosure may be applied. The car navigation device 2120 includes a processor 2121, a memory 2122, a global positioning system (GPS) module 2124, a sensor 2125, a data interface 2126, a content player 2127, a storage medium interface 2128, an input apparatus 2129, a display apparatus 2130, a speaker 2131, a wireless communication interface 2133, one or more antenna handovers 2136, one or more antennas 2137 and a battery 2138.

The processor 2121 may be, for example, a CPU or an SoC, and control a navigation function and another function of the car navigation device 2120. The memory 2122 includes an RAM and an ROM, and stores a program that is executed by the processor 2121, and data.

The GPS module 2124 measures a position (such as latitude, longitude and altitude) of the car navigation device 2120 based on a GPS signal received from a GPS satellite. The sensor 2125 may include a group of sensors such as a gyroscope sensor, a geomagnetic sensor, and an air pressure sensor. The data interface 2126 is connected to, for example, an in-vehicle network 2141 via a terminal not shown, and acquires data generated by the vehicle (such as vehicle speed data).

The content player 2127 reproduces content stored in a storage medium (such as a CD and a DVD) inserted into the storage medium interface 2128. The input apparatus 2129 includes, for example, a touch sensor configured to detect touch on a screen of the display apparatus 2130, a button, or a handover, and receives an operation or information inputted from a user. The display apparatus 2130 includes a screen such as an LCD or an OLED display, and displays an image of the navigation function or content that is reproduced. The speaker 2131 outputs sound of the navigation function or the content that is reproduced.

The wireless communication interface 2133 supports any cellular communication scheme (such as LTE and LTE-Advanced), and performs wireless communications. The wireless communication interface 2133 may typically include, for example, a BB processor 2134 and a RF circuit 2135. The BB processor 2134 may perform, for example, encoding/decoding, modulating/demodulating and multiplexing/de-multiplexing, and perform various types of signal processing for wireless communications. Meanwhile, the RF circuit 2135 may include, for example, a frequency mixer, a filter and an amplifier, and transmit and receive wireless signals via the antenna 2137. The wireless communication interface 2133 may also be a chip module on which the BB processor 2134 and the RF circuit 2135 are integrated. As shown in FIG. 22, the wireless communication interface 2133 may include multiple BB processors 2134 and multiple RF circuits 2135. Although FIG. 22 shows an example in which the wireless communication interface 2133 includes multiple BB processors 2134 and multiple RF circuits 2135, the wireless communication interface 2133 may include a single BB processor 2134 or a single RF circuit 2135.

Furthermore, in addition to the cellular communication scheme, the wireless communication interface 2133 may support another type of wireless communication scheme such as a short-distance wireless communication scheme, a near field communication scheme, and a wireless LAN scheme. In this case, the wireless communication interface 2133 may include a BB processor 2134 and a RF circuit 2135 for each type of wireless communication scheme.

Each of the antenna handovers 2136 handovers a connection destination of the antenna 2137 among multiple circuits (such as circuits for different wireless communication schemes) included in the wireless communication interface 2133.

Each of the antennas 2137 includes a single or multiple antenna elements (such as multiple antenna elements included in an MIMO antenna), and is used for the wireless communication interface 2133 to transmit and receive wireless signals. The car navigation device 2120 may include multiple antennas 2137, as shown in FIG. 22. Although FIG. 22 shows an example in which the car navigation device 2120 includes multiple antennas 2137, the car navigation device 2120 may include a single antenna 2137.

In addition, the car navigation device 2120 may include an antenna 2137 for each type of wireless communication scheme. In this case, the antenna handover 2136 may be omitted from the configuration of the car navigation device 2120.

The battery 2138 supplies power to blocks in the car navigation device 2120 shown in FIG. 22 via a feeder line which is indicated partially as a dashed line in FIG. 22. The battery 2138 accumulates power supplied from the vehicle.

In the car navigation device 2120 shown in FIG. 22, the transceiver unit 510 in the electronic device 500 described above with reference to FIG. 5 may be implemented by the wireless communication interface 2133 and the optional antenna 2137. The function of the control unit 520 in the electronic device 500 may be implemented by the processor 2121, and the function of the storage unit 530 may be implemented by the memory 2122. For example, the processor 2121 may implement the function of the control unit 520 by executing instructions stored in the memory 2122.

The technology of the present disclosure may also be implemented as an in-vehicle system (or a vehicle) 2140 including one or more blocks of the car navigation device 2120, the in-vehicle network 2141 and a vehicle module 2142. The vehicle module 2142 generates vehicle data (such as vehicle speed, engine speed, and fault information), and outputs the generated data to the in-vehicle network 2141.

Preferred embodiments of the present disclosure have been described above with reference to the drawings. However, the present disclosure is not limited to the above examples. Those skilled in the art may make various changes and modifications within the scope of the appended claims, and it should be understood that such changes and modifications naturally fall within the technical scope of the present disclosure.

For example, a unit shown by a dotted line box in the functional block diagram in the drawings indicates that the functional unit is optional in the corresponding apparatus, and the optional functional units may be combined appropriately to achieve desired functions.

For example, multiple functions implemented by one unit in the above embodiments may be implemented by separate apparatuses. Alternatively, multiple functions implemented by respective units in the above embodiments may be implemented by separate apparatuses, respectively. In addition, one of the above functions may be implemented by multiple units. Such configurations are naturally included in the technical scope of the present disclosure.

In the specification, steps described in the flowchart include not only the processes performed chronologically as the described sequence, but also the processes performed in parallel or individually rather than chronologically. Furthermore, the steps performed chronologically may be performed in another sequence appropriately.

Embodiments of the present disclosure are described above in detail in conjunction with the drawings. However, it should be understood that the embodiments described above are intended to illustrate the present disclosure rather than limit the present disclosure. Those skilled in the art may make various modifications and alternations to the above embodiments without departing from the spirit and scope of the present disclosure. Therefore, the scope of the present disclosure is defined by the appended claims and equivalents thereof.

1. An electronic device for wireless communications, comprising:
a processing circuit configured to:
interact with a network side device to perform a joint channel estimation or a joint beam scanning in cooperation with other terminal devices in a terminal device group,
wherein all terminal devices in the terminal device group have similar channel characteristics.

2. The electronic device according to claim 1, wherein the processing circuit is configured to:
transmit or receive a reference signal for a channel estimation based on a time resource and/or a frequency resource indicated by the network side device to perform the joint channel estimation, wherein the time resource and/or the frequency resource are different from a resource of the reference signal transmitted or received by at least another terminal device in the terminal device group.

3. The electronic device according to claim 2, wherein the time resource is different from a time resource of the reference signal transmitted or received by other terminal devices in the terminal device group;
wherein the time resource is the same as a time resource of the reference signal transmitted or received by a first terminal device in the terminal device group, and different from a time resource of the reference signal transmitted or received by a second terminal device in the terminal device group; or
wherein the frequency resource is in a different narrow frequency band from a frequency resource of the reference signal transmitted or received by at least another terminal device in the terminal device group.

4.-6. (canceled)

7. The electronic device according to claim 1, wherein the processing circuit is configured to:
transmit or receive a precoded reference signal for a channel estimation based on precoding information indicated by the network side device to perform the joint channel estimation, wherein a phase of the reference signal is different from a phase of the reference signal transmitted or received by at least another terminal device in the terminal device group.

8. The electronic device according to claim 2, wherein the joint channel estimation comprises a downlink channel estimation, and the similar channel characteristics comprise similar downlink channel characteristics, and
wherein the processing circuit is further configured to:
measure the received reference signal:
obtain, from each of other terminal devices in the terminal device group, a measurement result of the received reference signal by the terminal device; and
perform the downlink channel estimation based on a result of measuring the received reference signal and the obtained measurement result.

9. The electronic device according to claim 1, wherein the similar channel characteristics comprise similar uplink channel characteristics, and the processing circuit is further configured to:
transmit an uplink reference signal to the network side device by using one or more transmission beams to perform a joint beam scanning on the transmission beams of the uplink reference signal,
wherein the one or more transmission beams are different from a transmission beam used by at least another terminal device in the terminal device group to transmit the uplink reference signal.

10. The electronic device according to claim 9, wherein the processing circuit is further configured to:
obtain scanning beam information indicating the one or more transmission beams from the network side device or from another terminal device in the terminal device group; and/or
receive optimal beam information from the network side device, wherein the optimal beam information indicates an optimal transmission beam determined by the network side device based on the uplink reference signal received from each of the terminal devices in the terminal device group that is transmitted by using the respective transmission beam.

11. (canceled)

12. The electronic device according to claim 1, wherein the similar channel characteristics comprise similar uplink channel characteristics, and
wherein the processing circuit is configured to:
receive, using one or more reception beams, a downlink reference signal transmitted by the network side device using a transmission beam, so as to perform a joint beam scanning on the reception beams of the downlink reference signal,
wherein the one or more reception beams are different from a reception beam used by at least another terminal device in the terminal device group to receive the downlink reference signal.

13. The electronic device according to claim 12, wherein the processing circuit is further configured to:
obtain scanning beam information indicating the one or more reception beams from the network side device or a first terminal device in the terminal device group; and
report a measurement result of the downlink reference signal that is received by using the one or more reception beams to the network side device or the first terminal device;
obtain optimal beam information from the network side device or a first terminal device, wherein the optimal beam information indicates an optimal reception beam determined based on a measurement result by each of the terminal devices in the terminal device group; or
provide, to each of other terminal devices in the terminal device group, scanning beam information that indicates one or more reception beams used by the terminal device to receive the downlink reference signal; obtain a measurement result of the downlink reference signal that is received by using the indicated reception beams from each of the other terminal devices; and determine an optimal reception beam based on a measurement result by each of the terminal devices in the terminal device group.

14.-15. (canceled)

16. The electronic device according to claim 13, wherein the processing circuit is further configured to:
before the joint beam scanning, for the downlink reference signal transmitted by the network side device using the transmission beam, transmit an uplink reference signal in directions of the respective reception beams; and
receive beam adjustment information determined based on the received uplink reference signal from the network side device, and adjust beam directions of the respective reception beams based on the beam adjustment information for beam alignment,
wherein the scanning beam information is determined based on a result of the beam alignment of each of the terminal devices in the terminal device group.

17. An electronic device for wireless communications, comprising:
a processing circuit configured to:
interact with a terminal device in a terminal device group, wherein the terminal device performs a joint channel estimation or a joint beam scanning in cooperation with other terminal devices in the terminal device group,
wherein all terminal devices in the terminal device group have similar channel characteristics.

18. The electronic device according to claim 17, wherein the processing circuit is configured to:
indicate a time resource and/or a frequency resource of a reference signal for a channel estimation to the terminal device, so that the terminal device transmits or receives the reference signal based on the time resource and/or the frequency resource to perform the joint channel estimation, wherein the time resource and/or the frequency resource are different from a resource of the reference signal transmitted or received by at least another terminal device in the terminal device group.

19. The electronic device according to claim 18, wherein the time resource is different from a time resource of the reference signal transmitted or received by other terminal devices in the terminal device group;
wherein the time resource is the same as a time resource of the reference signal transmitted or received by a first terminal device in the terminal device group, and different from a time resource of the reference signal transmitted or received by a second terminal device in the terminal device group; or
wherein the frequency resource is in a different narrow frequency band from a frequency resource of the reference signal transmitted or received by at least another terminal device in the terminal device group.

20.-22. (canceled)

23. The electronic device according to claim 17, wherein the processing circuit is configured to:
indicate precoding information to the terminal device, so that the terminal device transmits or receives a precoded reference signal for a channel estimation based on the precoding information to perform the joint channel estimation, wherein a phase of the reference signal is different from a phase of the reference signal transmitted or received by at least another terminal device in the terminal device group.

24. The electronic device according to claim 18, wherein the joint channel estimation comprises an uplink channel estimation, and the similar channel characteristics comprise similar uplink channel characteristics, and
wherein the processing circuit is further configured to:
measure the reference signal received from each of the terminal devices in the terminal device group; and
perform the uplink channel estimation based on a result of the measurement.

25. The electronic device according to claim 17, wherein the similar channel characteristics comprise similar uplink channel characteristics, and the processing circuit is configured to:
receive an uplink reference signal that is transmitted by using one or more respective transmission beams from each of the terminal devices in the terminal device group, so as to perform a joint beam scanning on the transmission beams of the uplink reference signal,
wherein a transmission beam of each of the terminal devices is different from a transmission beam used by at least another terminal device in the terminal device group to transmit the uplink reference signal.

26. The electronic device according to claim 25, wherein the processing circuit is further configured to:
transmit scanning beam information indicating the one or more transmission beams to the terminal device in the terminal device group; and/or
determine an optimal transmission beam based on the uplink reference signal received from each of the terminal devices in the terminal device group that is transmitted using the respective transmission beam; and transmit optimal beam information indicating the optimal transmission beam to each of the terminal devices in the terminal device group.

27. (canceled)

28. The electronic device according to claim 17, wherein the similar channel characteristics comprise similar uplink channel characteristics, and
wherein the processing circuit is further configured to:
transmit a downlink reference signal to the terminal device in the terminal device group by using a transmission beam, so that the terminal device receives the downlink reference signal by using one or more reception beams to perform a joint beam scanning on the reception beams of the downlink reference signal,
wherein the one or more reception beams are different from a reception beam used by at least another terminal device in the terminal device group to receive the downlink reference signal.

29. The electronic device according to claim 28, wherein the processing circuit is further configured to:
provide, to each of the terminal devices in the terminal device group, scanning beam information indicating one or more reception beams to the terminal device:
obtain, from each of the terminal devices in the terminal device group, a measurement result of the downlink reference signal that is received by using the indicated one or more reception beams; and
determine an optimal reception beam based on the obtained measurement result.

30. (canceled)

31. A wireless communication method, comprising:
interacting with a network side device to perform a joint channel estimation or a joint beam scanning in cooperation with other terminal devices in a terminal device group,
wherein all terminal devices in the terminal device group have similar channel characteristics.

32.-33. (canceled)
